(19) United States
(12) Patent Application Publication
(10) Pub. No.: US 2023/0070233 A1
(43) Pub. Date: Mar. 9, 2023

(54) METHOD AND SYSTEM FOR PERFORMING MULTICAST GROUP PAGING FOR MBS MULTICAST SESSION ACTIVATION NOTIFICATION

(71) Applicant: Samsung Electronics Co., Ltd., Suwon-si (KR)

(72) Inventors: Vinay Kumar SHRIVASTAVA, Bangalore (IN); Sriganesh RAJENDRAN, Bangalore (IN); Varini GUPTA, Bangalore (IN)

(21) Appl. No.: 17/903,592

(22) Filed: Sep. 6, 2022

(30) Foreign Application Priority Data
Sep. 6, 2021 (IN) 202141040403
Oct. 21, 2021 (IN) 202141048041
Aug. 23, 2022 (IN) 2021 41040403

(51) Int. Cl. H04W 76/40; H04W 68/02; H04W 76/27

(52) U.S. Cl. CPC H04W 76/40; H04W 68/02; H04W 76/27

(57) ABSTRACT

The disclosure relates to a fifth generation (5G) or sixth generation (6G) communication system for supporting a higher data transmission rate. A method is provided. The method includes receiving, by a Next Generation Radio Access Network (NG-RAN) node, a multicast group paging message from an Access and Mobility Management Function (AMF) node, determining, by the NG-RAN node, one or more User Equipment (UE) that has to be page (e.g., multicast group paging) for the MBS multicast session activation notification based on the received multicast group paging message, performing, by the NG-RAN node, the multicast group paging for one or more determined UE, wherein the NG-RAN node pages the MBS multicast session activation notification to one or more determined UE.

### CROSS-REFERENCE TO RELATED APPLICATION(S)

This application is based on and claims priority under 35 U.S.C. § 119(a) of an Indian provisional patent application number 202141040403, filed on Sep. 6, 2021, in the Indian Patent Office, of an Indian provisional patent application number 202141048041, filed on Oct. 21, 2021, in the Indian Patent Office, and of an Indian complete patent application number 202141040403, filed on Aug. 23, 2022, in the Indian Patent Office, the disclosure of each of which is incorporated by reference herein in its entirety.

### BACKGROUND

### 1. Field

The disclosure relates to a wireless network. More particularly, the disclosure relates to a method and a system for performing multicast group paging for Multicast Broadcast Services (MBS) multicast session activation notification in the wireless network.

### 2. Description of Related Art

Fifth generation (5G) mobile communication technologies define broad frequency bands such that high transmission rates and new services are possible, and can be implemented not only in “Sub 6 Gigahertz (GHz)” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for performing multicast group paging for Multicast Broadcast Services (MBS) multicast session activation notification in a wireless network by sending a multicast group paging message. The multicast group paging message is used to carry User Equipment (UE) identity index value to enable network nodes to identify UEs that need to be paged for multicast session activation. As a result, the UEs know about a status of the multicast session activation and return to a radio resource control (RRC) connected state from an RRC idle state or an RRC inactive state to resume a multicast session.

Another aspect of the disclosure is to provide the method for performing the multicast group paging for the MBS multicast session activation notification in the wireless network. The method includes a multicast group paging procedure and a message to enable an Access and Mobility Management Function (AMF) to notify the UEs for CM-idle UEs, as newly mentioned in third generation partnership project (3GPP) TS 38.413 v17.0.0 clauses 8.5.2 and 9.2.4.2.

Another aspect of the disclosure is to provide the method for performing the multicast group paging for the MBS multicast session activation notification in the wireless network. The method includes a Radio Access Network (RAN) multicast group paging procedure and a message to enable a gNodeB (gNB) to request paging of the UEs to other gNBs, as newly mentioned in 3GPP TS 38.423 v17.0.0 clauses 8.2.11 and 9.1.1.15.

Another aspect of the disclosure is to provide the method for performing the multicast group paging for the MBS multicast session activation notification in the wireless network. The method includes a multicast group paging procedure and a message on an F1 interface (gNB-CU to gNB-DU) to enable the gNB-DU to the multicast group page for the UEs, as newly mentioned in 3GPP TS 38.423 v17.0.0 clauses 8.14.5 and 9.2.14.1.

Additional aspects will be set forth in part in the description which follows and, in part, will be apparent from the description, or may be learned by practice of the presented embodiments.

In accordance with an aspect of the disclosure, a method for performing multicast group paging for Multicast Broadcast Services (MBS) multicast session activation notification in a wireless network is provided. The method includes receiving, by a Next Generation Radio Access Network (NG-RAN) node, a multicast group paging message from an Access and Mobility Management Function (AMF) node, determining, by the NG-RAN node, one or more User Equipment (UE) that has to be paged (e.g., multicast group paging) for the MBS multicast session activation notification based on the received multicast group paging message, determining, by the NG-RAN node, one or more Paging Occasion (PO) to send the page for the MBS multicast session activation notification based on the received multicast group paging message, and performing, by the NG-RAN node, the multicast group paging for one or more determined UE, wherein the NG-RAN node pages the MBS multicast session activation notification to one or more determined UE based on the determined one or more PO.

In an embodiment, the multicast group paging message includes a message type, an MBS session identity (ID), an MBS service area, a multicast group paging area list, a multicast group paging area item, a multicast group paging area, a UE paging list, a UE paging item, a UE identity index value, a paging Discontinuous reception (DRX) including one or more a UE specific DRX parameter and a common DRX parameter.

In an embodiment, one or more UE operates in a Radio Resource Control (RRC) idle state or an RRC inactive state with a non-activated MBS multicast session as indicated by the MBS session ID in the multicast group paging message.

In an embodiment, the performing, by the NG-RAN node, of the multicast group paging for one or more determined UE based on the determined one or more PO includes sending, by the NG-RAN node, the multicast group paging to one or more determined UE for the MBS multicast session activation notification for all POs, or sending, by the NG-RAN node, the multicast group paging to one or more determined UE for the MBS multicast session activation notification for relevant POs for one or more UE with a non-activated MBS multicast session, where the relevant POs are determined based on the received UE identity index value in the multicast group paging.

In an embodiment, the method includes initiating, by one or more UE, at least one of an RRC setup request and an RRC resume request to transition to an RRC connected state from the RRC idle state or the RRC inactive state to activate the MBS multicast session upon receiving the MBS multicast session activation notification from the NG-RAN node. Further, the method includes activating, by one or more UE, the MBS multicast session to start or resume one or more multicast service (e.g., RRC connection establishment or RRC connection resumption, etc.) in the wireless network.

In an embodiment, the sending of the MBS multicast session activation notification for all POs or the relevant POs is based on at least one factor of number of UEs to be paged in a cell, a paging resource availability with the NG-RAN node, and a specified group paging behaviour of the NG-RAN node or a capability of the NG-RAN node.

In accordance with another aspect of the disclosure, a method for performing the multicast group paging for the MBS multicast session activation notification in the wireless network is provided. The method includes receiving, by a second Next Generation Radio Access Network (NG-RAN) node, a Radio Access Network (RAN) multicast group paging message from a first NG-RAN node, determining, by the second NG-RAN node, one or more UE that has to be paged for the MBS multicast session activation notification based on the received RAN multicast group paging message, determining, by the second NG-RAN node, one or more PO to send the page for the MBS multicast session activation notification based on the received RAN multicast group paging message, and performing, by the second NG-RAN node, the multicast group paging for one or more determined UE, where the second NG-RAN node pages the MBS multicast session activation notification to one or more determined UE based on the determined one or more PO.

In an embodiment, the RAN multicast group paging message includes the message type, the MBS session ID, a UE identity index list, a UE identity index item, a UE identity index value, an index length, the paging DRX including one or more a UE specific DRX parameter and a common DRX parameter, and multicast RAN paging area.

In an embodiment, one or more UE operates in the RRC idle state or the RRC inactive state with the non-activated MBS multicast session.

In an embodiment, the performing, by the second NG-RAN node, of the multicast group paging for one or more determined UE based on the determined one or more PO includes sending, by the second NG-RAN node, the multicast group paging to one or more determined UE for the MBS multicast session activation notification for all POs, or sending, by the second NG-RAN node, the multicast group paging to one or more determined UE for the MBS multicast session activation notification for the relevant POs for one or more UE with the non-activated MBS multicast session, where the relevant POs are determined based on the received UE identity index value in the RAN multicast group paging.

In an embodiment, the method includes initiating, by one or more UE, the RRC setup request and/or the RRC resume request to transition to the RRC connected state from the RRC idle state or the RRC inactive state to activate the MBS multicast session upon receiving the MBS multicast session activation notification from the second NG-RAN node. Further, the method includes activating, by one or more UE, the MBS multicast session to start or resume one or more multicast service in the wireless network.

In accordance with another aspect of the disclosure, a method for performing the multicast group paging for the MBS multicast session activation notification in the wireless network is provided. The method includes receiving, by a gNodeB Distributed Unit (gNB-DU) node, a multicast group paging message from a gNodeB Centralized Unit (gNB-CU) node. Further, the method includes determining, by the gNB-DU node, one or more UE that has to be paged for the MBS multicast session activation notification based on the received multicast group paging message, determining, by the gNB-DU node, one or more PO to send a page for the MBS multicast session activation notification based on the received multicast group paging message, and performing, by the gNB-DU node, the multicast group paging for one or more determined UE, where the gNB-DU node pages the MBS multicast session activation notification to one or more determined UE based on the determined one or more PO.

In an embodiment, the multicast group paging message includes the message type, the MBS session ID, a UE identity list for paging, a UE identity for paging item, the UE identity index value, the paging DRX including one or more the UE specific DRX parameter and the common DRX parameter, a paging cell list, and a paging cell item.

In an embodiment, one or more UE operates in the RRC idle state or the RRC inactive state with the non-activated MBS multicast session as indicated by the MBS session ID in the multicast group paging message.

In an embodiment, the performing, by the gNB-DU node, of the multicast group paging for one or more determined UE based on the determined one or more PO includes sending, by the gNB-DU node, the multicast group paging to one or more determined UE for the MBS multicast session activation notification for all POs, or sending, by the gNB-DU node, the multicast group paging to one or more determined UE for the MBS multicast session activation notification for the relevant POs for one or more UE with the non-activated MBS multicast session, where the relevant POs are determined based on the received UE identity index value in the multicast group paging.

In an embodiment, the method includes initiating, by one or more UE, the RRC setup request and/or the RRC resume request to transition to the RRC connected state from the RRC idle state or the RRC inactive state to activate the MBS multicast session upon receiving the MBS multicast session activation notification from the gNB-DU node. Further, the method includes activating, by one or more UE, the MBS multicast session to start or resume one or more multicast service in the wireless network.

In accordance with another aspect of the disclosure, a method for performing the multicast group paging for the MBS multicast session activation notification in the wireless network is provided. The method includes receiving, by the UE, the MBS multicast session activation notification from the NG-RAN node and/or the gNB-DU node, where the UE operates in the RRC idle state or the RRC inactive state, initiating, by the UE, the RRC setup request and/or the RRC resume request to transition to the RRC connected state from the RRC idle state or the RRC inactive state to activate the MBS multicast session upon receiving the MBS multicast session activation notification, and activating, by the UE, the MBS multicast session to start or resume one or more multicast service in the wireless network.

In accordance with another aspect of the disclosure, an NG-RAN node for performing the multicast group paging for the MBS multicast session activation notification in the wireless network is provided. The NG-RAN node includes a memory, a processor, and a group paging controller operably connected to the processor and the memory. The group paging controller is configured to receive the multicast group paging message from the AMF node and/or the RAN multicast group paging message from other NG-RAN node, determine one or more UE that has to be paged for the MBS multicast session activation notification based on the received multicast group paging message and/or the received RAN multicast group paging message, determine one or more PO to send the page for the MBS multicast session activation notification based on the received multicast group paging message and/or the received RAN multicast group paging message, and perform the multicast group paging for one or more determined UE, wherein the NG-RAN node pages the MBS multicast session activation notification to one or more determined UE based on the determined one or more PO.

In accordance with another aspect of the disclosure, an AMF node for performing the multicast group paging for the MBS multicast session activation notification in the wireless network is provided. The AMF node includes a memory, a processor, and a group paging controller operably connected to the processor and the memory. The group paging controller is configured to receive an MBS session notification request from a SMF node, send the multicast group paging message to the NG-RAN node upon receiving the MBS session notification request.

In accordance with another aspect of the disclosure, a gNB-DU node for performing the multicast group paging for the MBS multicast session activation notification in the wireless network is provided. The gNB-DU node includes a memory, a processor, and a group paging controller operably connected to the processor and the memory. The group paging controller is configured to receive the multicast group paging message from the gNB-CU node, determine one or more UE that has to be paged for the MBS multicast session activation notification based on the received multicast group paging message, determine one or more PO to send the page for the MBS multicast session activation notification based on the received multicast group paging message, and perform the multicast group paging for one or more determined UE, where the gNB-DU node pages the MBS multicast session activation notification to one or more determined UE based on the determined one or more PO.

In accordance with another aspect of the disclosure, a UE node for performing the multicast group paging for the MBS multicast session activation notification in the wireless network is provided. The UE node includes a memory, a processor, and a group paging controller operably connected to the processor and the memory. The group paging controller is configured to receive the MBS multicast session activation notification from the NG-RAN node and/or the gNB-DU node, where the UE operates in the RRC idle state or the RRC inactive state, initiate the RRC setup request and/or the RRC resume request to transition to the RRC connected state from the RRC idle state or the RRC inactive state to activate the MBS multicast session upon receiving the MBS multicast session activation notification, and activate the MBS multicast session to start or resume one or more multicast service in the wireless network.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a Multicast Broadcast Service (MBS) delivery from a 5^{th} Generation (5G) Core Network (CN) to a 5G Radio Access Network (RAN) and one or more User Equipment (UEs), according to an embodiment of the disclosure;

FIG. 2 illustrates a scenario of multicast session states and state transitions, according to an embodiment of the disclosure;

FIG. 3A illustrates a sequence diagram for sending multicast session activation notification for UE(s) in an RRC idle state using a unicast paging, according to an embodiment of the disclosure;

FIG. 3B illustrates a sequence diagram for sending the multicast session activation notification for the UE(s) in an RRC inactive state using the unicast paging, according to an embodiment of the disclosure;

FIG. 4A illustrates a block diagram of a UE for performing a multicast group paging for an MBS multicast session activation notification in a wireless network, according to an embodiment of the disclosure;

FIG. 4B illustrates a block diagram of a NG-RAN node for performing the multicast group paging for the MBS multicast session activation notification in the wireless network, according to an embodiment of the disclosure;

FIG. 4C illustrates a block diagram of an AMF node for performing the multicast group paging for the MBS multicast session activation notification in the wireless network, according to an embodiment of the disclosure;

FIG. 4D illustrates a block diagram of a gNB-DU node for performing the multicast group paging for the MBS multicast session activation notification in the wireless network, according to an embodiment of the disclosure;

FIG. 5A illustrates a sequence diagram for sending the multicast session activation notification for the UE(s) in the RRC idle state using group paging on all legacy paging occasions, according to an embodiment of the disclosure;

FIG. 5B illustrates a sequence diagram for sending the multicast session activation notification for the UE(s) in the RRC idle state using the group paging on relevant paging occasions for the UEs with a non-activated multicast session(s), according to an embodiment of the disclosure;

FIG. 5C illustrates a sequence diagram for sending the multicast session activation notification for the UE(s) in the RRC idle state using the group paging on relevant paging occasions for the UEs with the non-activated multicast session(s), according to an embodiment of the disclosure;

FIG. 6A illustrates a sequence diagram for sending the multicast session activation notification for the UE(s) in the RRC inactive state using the group paging on all legacy paging occasions, according to an embodiment of the disclosure;

FIG. 6B illustrates a sequence diagram for sending the multicast session activation notification for the UE(s) in the RRC inactive state using the group paging on the relevant paging occasions for the UEs with the non-activated multicast session(s), according to an embodiment of the disclosure;

FIG. 7 illustrates a sequence diagram for sending the multicast session activation notification for the UE(s) in an RRC connected state using dedicated signalling, according to an embodiment of the disclosure;

FIG. 8 illustrates a sequence diagram for sending the multicast session activation notification for the UE(s) in the RRC inactive state using the group paging on the relevant paging occasions for the UEs with the non-activated multicast session(s) using an Xn message, according to an embodiment of the disclosure;

FIG. 9 illustrates a sequence diagram for sending the multicast session activation notification for the UE(s) in the RRC inactive state using the group paging on the relevant paging occasions for the UEs with the non-activated multicast session(s) using an F1 interface, according to an embodiment of the disclosure;

FIGS. 10A and 10B illustrate sequence diagrams where the UEs operates in the RRC connected state which receives an RRC reconfiguration message for relevant multicast session configuration and/or activation and/or deactivation, according to various embodiments of the disclosure;

FIG. 11 illustrates a sequence diagram for sending the multicast session activation notification for the UE(s) in the RRC idle state using the group paging on relevant paging occasions for the UEs related to a TMGI, according to an embodiment of the disclosure; and

FIG. 12 illustrates a sequence diagram for sending the multicast session activation notification for the UE(s) in the RRC inactive state by bundling an N2 SM message of all UEs to be signalled along with TMGI and corresponding UE identity index value, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

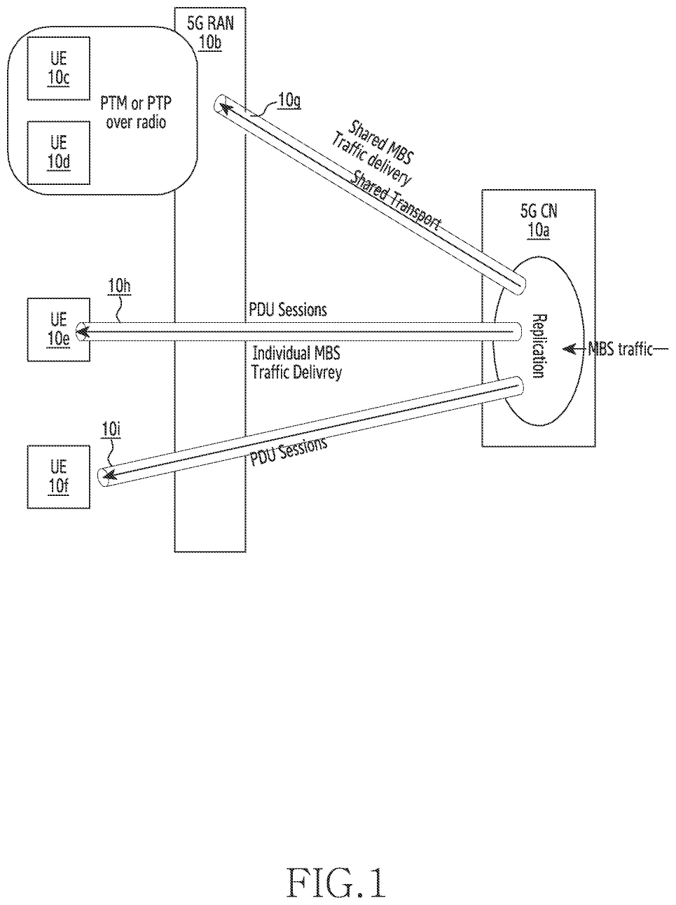

FIG. 1 illustrates a Multicast Broadcast Service (MBS) delivery from a 5^{th} Generation (5G) Core Network (CN) to a 5G Radio Access Network (RAN) and one or more User Equipment (UEs), according to an embodiment of the disclosure.

Referring to FIG. 1, the 5G CN (10a) delivers the MBS user data to a 5G Radio Access Network (RAN) (10b) using an individual delivery (10h and 10i) and/or shared delivery (10g).

Individual delivery (10h and 10i): Each UE (10e and 10f) receives the MBS service, and the 5G CN (10a) delivers separate copies of MBS user data packets to the 5G RAN (10b) (i.e. via per-UE Protocol Data Unit (PDU) sessions, alike in case of unicast delivery).

Shared delivery (10g): the 5G CN (10a) delivers a single copy of the MBS user data to the 5G RAN (10b) (i.e. via a shared PDU session/tunnel), with the RAN that handles delivery of the MBS user data to one or multiple UEs (10c and 10d). In the case of the shared delivery (10g) by the 5G CN (10a), the 5G RAN (10b) delivers the MBS data to the UEs (10c and 10d) using either Point-to-Point delivery (PTP) or Point-to-Multipoint (PTM) delivery.

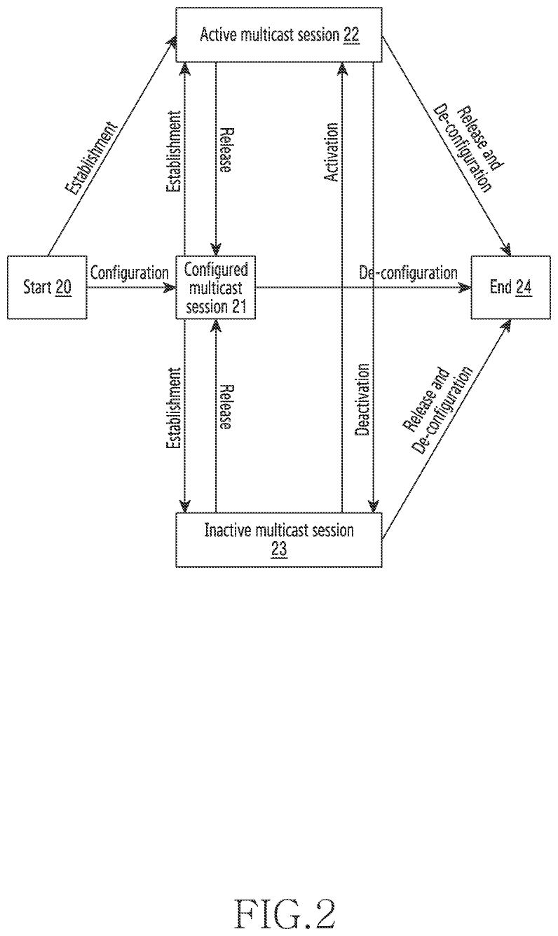

FIG. 2 illustrates a scenario of multicast session states and state transitions, according to an embodiment of the disclosure.

Referring to FIG. 2, a multicast session can transit through different states in the NR MBS communication. The different states include a start (20), a configured multicast session (21), an active multicast session (22), an inactive multicast session (23), and an end (24). Multicast session can be configured to the configured multicast session (21) or activated to the active multicast session (22) or deactivated to the inactive multicast session (23) or de-configured/released to the end (24).

There are some issues with following aspects of a multicast session activation notification/MBS multicast session activation notification in existing NR MBS communication. The existing NR MBS communication does not disclose how to maximize paging resource efficiency for the multicast session activation notification while not negatively impacting paging capacity of legacy nodes, no prior specification exists for group paging approaches for the MBS multicast session activation notification, for example, sending the MBS multicast session activation notification from an Access and Mobility Management Function (AMF) to Connection Management-idle (CM-idle) UEs, a gNodeB (gNB) to gNB(s) and a gNodeB Centralized Unit (gNB-CU) to a gNodeB Distributed Unit (gNB-DU). Furthermore, the existing NR MBS communication does not explain how a mechanism works for the UEs (e.g., 10c) in various Radio Resource Control (RRC) states, such as RRC idle state and RRC inactive state. There is a need for a method to notify the UEs that have moved to the RRC idle/RRC inactive state, from an RRC connected, with a non-activated multicast session about multicast session activation. Without the method, the UEs would be unaware of status of the multicast session and would be unable to return to an RRC connected state to resume the multicast session. Furthermore, the existing NR MBS communication does not specify how to ensure that a mechanism works for different capability nodes and/or legacy nodes (e.g., MBS and non-MBS nodes) that may or may not support MBS. Furthermore, the existing NR MBS communication does not reveal what and how signalling messages and interactions are performed over interfaces between different network entities (e.g., MBS and non-MBS nodes).

Thus, it is desired to address the above-mentioned disadvantages or other shortcomings or at least provide a useful alternative for performing multicast group paging for the MBS multicast session activation notification in a wireless network.

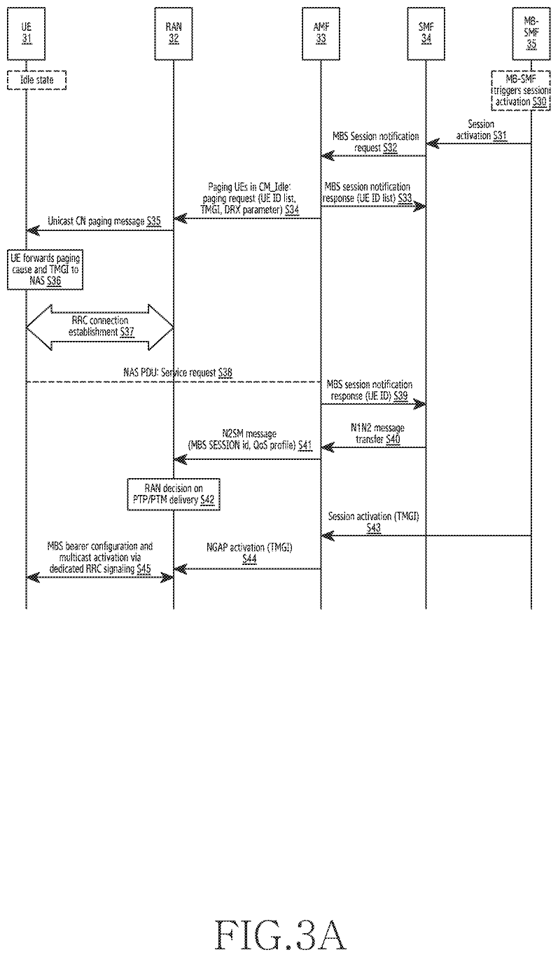

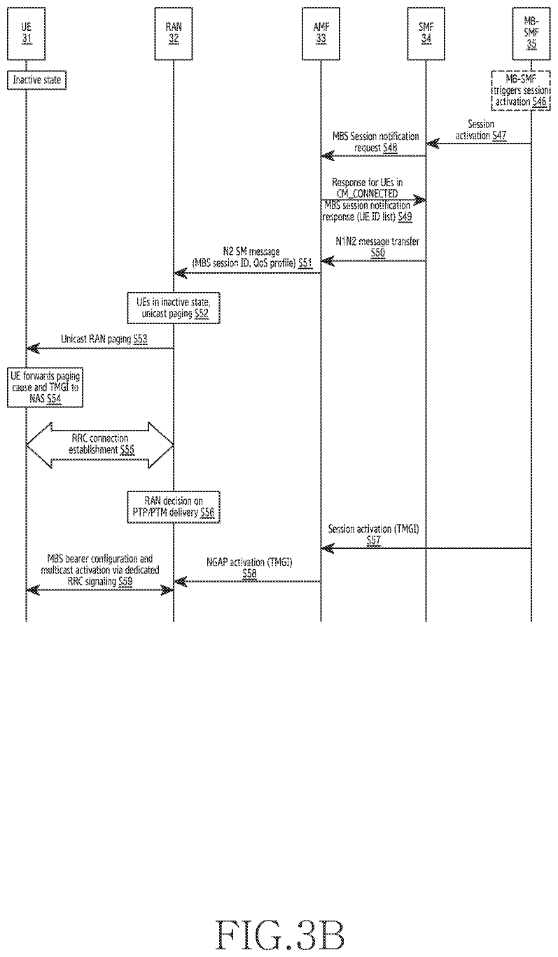

FIG. 3A illustrates a sequence diagram for sending multicast session activation notification for UE(s) in an RRC idle state using unicast paging, according to an embodiment of the disclosure. The sequence diagram includes various network entities such as a User Equipment (UE) (31), a Radio Access Network (RAN) (32), an Access and Mobility Management Function (AMF) (33), a Session Management Function (SMF) (34), and a Multicast Broadcast Session Management Function (MB-SMF) (35).

At operation S30, the MB-SMF (35) triggers session (e.g., MBS session) activation, where the session activation may be triggered by the following events,

When a Multicast Broadcast User Plane Function (MB-UPF) (not shown in FIG. 3A) receives downlink data for the MBS session, the MB-UPF sends an MB-N4 notification (N4 Session ID) to the MB-SMF node (500) for activating the MBS session.

An Application Function (AF) (not shown in FIG. 3A) sends an MBS activation request (TMGI) to the MB-SMF (35) directly or via a Network Exposure Function (NEF) ((not shown in FIG. 3A)).

At operation S31, the MB-SMF (35) sends a session activation notification (TMGI) to one or more SMF (34). Based on the received TMGI, the SMF (34) finds a list of UEs (31) that joined the MBS session identified by the TMGI. If the SMF (34) determines a user plane of an associated PDU session(s) of the UE(s) (31) with respect to the TMGI are activated already, operations S32-S38 will be skipped for the UE (31).

At operation S32, the SMF (34) sends an MBS session notification request to the AMF (33), including (UE list, and TMGI). After receiving the MBS session notification request, for each UE (31) in the list, the AMF (33) determines a CM state of the UE (31), as given in operations S33-S36. At operation S33, if the UE (31) involved in the MBS session operates in a CM-connected state, then the AMF (33) responds to the list of the UE (31) involved in the MBS session and in the CM-connected state, using an MBS session notification response (UE list). Operations S34-S35 will not be executed for that UEs (31) in the list.

At operation S34, if the AMF (33) determines that there are any UEs operates in a CM-IDLE state (i.e. RRC_IDLE) and involved in the MBS session, then the AMF (33) figures out a paging area considering all the UE(s) (31), which need to be paged. The AMF (33) sends a paging request message to the NG-RAN node(s) (e.g., one or more RAN (32)) belonging to the paging area with the TMGI as the identifier to be paged if the related RAN (32) support the MBS session. At operation S35, after receiving the paging request, the RAN (32) initiates a paging procedure for sending CN paging for the UEs (31) in the list, where the RAN (32) sends the CN paging through a legacy unicast paging message to the UEs (31) in the list.

At operations S36-S37, the UE (31) forwards a paging cause and the TMGI to a NAS and established an RRC connection with the RAN (32). At operation S38, the UE (31) operates in the IDLE state sends a service request to the AMF (33). At operation S39, after receiving the service request sent by the UE (31), the AMF (33) responds to the SMF (34) with an MBS session notification response (UE ID). At operations S40-S41, after receiving the MBS session notification response, the SMF (34) determines the related UE (31) operating in the CM-connected state and sends a Namf_Communication_N1N2 message transfer (e.g., N2 SM message (MBS Session identifier, associated QoS profiles) to the RAN (32) via the AMF (33) for the UE (31) which is identified in operation S32. The AMF (33) sends a N2 request message (e.g., N2 SM message (MBS Session identifier, associated QoS profiles) to the RAN node (32).

At operation S42, after receiving the N2 message, the RAN node (32) takes decision on PTP/PTM delivery. If the shared tunnel has not been established before, the shared tunnel is established at this step. In addition, the RAN node (32) responses to the SMF (34). The RAN node (32) configures the UE (31) with the RRC messages if needed. At operation S43, the MB-SMF (35) sends a session activation (TMGI) to the AMF (33). At operations S44-S45, the AMF (33) sends a NGAP activation message (TMGI) to the RAN node (32). After receiving the NGAP activation message, the RAN node (32) determines the RRC state of the related UE (31), and configures an MBS bearer and sends a multicast activation via dedicated RRC signalling.

FIG. 3B illustrates a sequence diagram for sending multicast session activation notification for the UE(s) (31) in an RRC inactive state using the unicast paging, according to an embodiment of the disclosure.

At operation S46, the MB-SMF (35) triggers session (e.g., MBS session) activation, where the session activation may be triggered by the following events,

When the MB-UPF (not shown in FIG. 3B) receives downlink data for an MBS session, the MB-UPF sends the MB-N4 notification (N4 Session ID) to the MB-SMF node (500) for activating the MBS session.

The AF (not shown in FIG. 3A) sends the MBS activation request (TMGI) to the MB-SMF (35) directly or via the NEF ((not shown in FIG. 3B)).

At operation S47, the MB-SMF (35) sends the session activation notification (TMGI) to one or more SMF (34). Based on the received TMGI, the SMF (34) finds the list of UEs (31) that joined the MBS session identified by the TMGI. If the SMF (34) determines the user plane of an associated PDU session(s) of the UE(s) (31) with respect to the TMGI are activated already, operations S48-S54 will be skipped for the UE (31).

At operation S48, the SMF (34) sends the MBS session notification request to the AMF (33), including (UE list, and TMGI). After receiving the MBS session notification request, for each UE (31) in the list, the AMF (33) determines the CM state of the UE (31), as given in operations S49-S51. At operation S49, if the UE (31) involved in the MBS session operates in the CM-connected state, the AMF (33) responds to the list of the UE (31) involved in the MBS Session and in the CM-connected state, using the MBS session notification response (UE list). Operations S50-S51 will not be executed for that UEs (31) in the list. At operations S50-S51, after receiving MBS session notification response, the SMF (34) determines the related UE (31) operates in the CM-connected state and sends the Namf_Communication_N1N2 message transfer (e.g., N2 SM message (MBS Session identifier, associated QoS profiles) to the RAN (32) via the AMF (33) for the UE (31) which is identified in operation S48. The AMF (33) sends the N2 request message (e.g., N2 SM message (MBS Session identifier, associated QoS profiles) to the RAN node (32).

At operations S52-53, the RAN node (32) performs the unicast RAN paging as the UEs (31) operates in the RRC inactive state and initiates a paging procedure for sending paging for the UEs (31) in the list, where the RAN (32) sends the paging through the legacy unicast paging message to the UEs (31) in the list.

At operations S54-S55, the UE (31) forwards a paging cause and the TMGI to the NAS and established the RRC connection with the RAN (32). At operation S56, the RAN node (32) takes decision on the PTP/PTM delivery. If the shared tunnel has not been established before, the shared tunnel is established at this step. In addition, RAN node (32) responses to the SMF (34). The RAN node (32) configures the UE (31) with RRC messages if needed. At operation S57, the MB-SMF (35) sends the session activation (TMGI) to the AMF (33). At operations S58-59, the AMF (33) sends the NGAP activation message (TMGI) to the RAN node (32). After receiving the NGAP activation message, the RAN node (32) determines the RRC state of the related UE (31), and configures MBS bearer and sends multicast activation via the dedicated RRC signalling.

The following Table-1 shows an example of a paging message format that was transmitted by the AMF (33) to the RAN (32) utilising unicast paging, but additionally including TMGI information.

TABLE 1

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | ignore |
| UE Paging | M | | 9.3.3.18 | | YES | ignore |
| Identity | | | | | | |
| Paging DRX | O | | 9.3.1.90 | | YES | ignore |
| TAI List for | | 1 | | | YES | ignore |
| Paging | | | | | | |
| >TAI List for | | 1 . . . | | | — | |
| Paging Item | | <maxnoofTAIforPaging> | | | | |
| >>TAI | M | | 9.3.3.11 | | — | |
| Paging Priority | O | | 9.3.1.78 | | YES | ignore |
| UE Radio | O | | 9.3.1.68 | | YES | ignore |
| Capability for | | | | | | |
| Paging | | | | | | |
| Paging Origin | O | | 9.3.3.22 | | YES | ignore |
| Assistance Data | O | | 9.3.1.69 | | YES | ignore |
| for Paging | | | | | | |
| NB-IoT Paging | O | | 9.3.1.138 | | YES | ignore |
| eDRX | | | | | | |
| Information | | | | | | |
| NB-IoT Paging | O | | 9.3.1.139 | If this IE is | YES | ignore |
| DRX | | | | present, the | | |
| | | | | Paging | | |
| | | | | DRXAE is | | |
| | | | | ignored. | | |
| Enhanced | O | | 9.3.1.140 | | YES | ignore |
| Coverage | | | | | | |
| Restriction | | | | | | |
| WUS Assistance | O | | 9.3.1.143 | | YES | ignore |
| Information | | | | | | |
| Paging eDRX | O | | 9.3.1.154 | | YES | ignore |
| Information | | | | | | |
| CE-mode-B | O | | 9.3.1.155 | | YES | ignore |
| Restricted | | | | | | |
| TMGI | O | | | | YES | ignore |

Accordingly, the embodiment herein is to provide a method for performing multicast group paging for Multicast Broadcast Services (MBS) multicast session activation notification in a wireless network. The method includes receiving, by a Next Generation Radio Access Network (NG-RAN) node, a multicast group paging message from an Access and Mobility Management Function (AMF) node. Further, the method includes determining, by the NG-RAN node, one or more User Equipment (UE) that has to be paged (e.g., multicast group paging) for the MBS multicast session activation notification based on the received multicast group paging message. Further, the method includes determining, by the NG-RAN node, one or more Paging Occasion (PO) to send the page for the MBS multicast session activation notification based on the received multicast group paging message. Further, the method includes performing, by the NG-RAN node, the multicast group paging for one or more determined UE, where the NG-RAN node pages the MBS multicast session activation notification to one or more determined UE based on the determined one or more PO.

Accordingly, the embodiment herein is to provide a method for performing the multicast group paging for the MBS multicast session activation notification in the wireless network. The method includes receiving, by a second Next Generation Radio Access Network (NG-RAN) node, a Radio Access Network (RAN) multicast group paging message from a first NG-RAN node. Further, the method includes determining, by the second NG-RAN node, one or more UE that has to be paged for the MBS multicast session activation notification based on the received RAN multicast group paging message. Further, the method includes determining, by the second NG-RAN node, one or more PO to send the page for the MBS multicast session activation notification based on the received RAN multicast group paging message. Further, the method includes performing, by the second NG-RAN node, the multicast group paging for one or more determined UE, where the second NG-RAN node pages the MBS multicast session activation notification to one or more determined UE based on the determined one or more PO.

Accordingly, the embodiment herein is to provide a method for performing the multicast group paging for the MBS multicast session activation notification in the wireless network. The method includes receiving, by a gNodeB Distributed Unit (gNB-DU) node, a multicast group paging message from a gNodeB Centralized Unit (gNB-CU) node. Further, the method includes determining, by the gNB-DU node, one or more UE that has to be paged for the MBS multicast session activation notification based on the received multicast group paging message. Further, the method includes determining, by the gNB-DU node, one or more PO to send a page for the MBS multicast session activation notification based on the received multicast group paging message. Further, the method includes performing, by the gNB-DU node, the multicast group paging for one or more determined UE, where the gNB-DU node pages the MBS multicast session activation notification to one or more determined UE based on the determined one or more PO.

Accordingly, the embodiment herein is to provide a method for performing the multicast group paging for the MBS multicast session activation notification in the wireless network. The method includes receiving, by the UE, the MBS multicast session activation notification from the NG-RAN node and/or the gNB-DU node, where the UE operates in the RRC idle state or the RRC inactive state. Further, the method includes initiating, by the UE, the RRC setup request and/or the RRC resume request to transition to the RRC connected state from the RRC idle state or the RRC inactive state to activate the MBS multicast session upon receiving the MBS multicast session activation notification. Further, the method includes activating, by the UE, the MBS multicast session to start or resume one or more multicast service in the wireless network.

Accordingly, the embodiments herein provide the NG-RAN node for performing the multicast group paging for the MBS multicast session activation notification in the wireless network. The NG-RAN node includes a group paging controller coupled with a processor and a memory. The group paging controller receives the multicast group paging message from the AMF node and/or the RAN multicast group paging message from other NG-RAN node. Further, the group paging controller determines one or more UE that has to be paged for the MBS multicast session activation notification based on the received multicast group paging message and/or the received RAN multicast group paging message. Further, the group paging controller determines one or more PO to send the page for the MBS multicast session activation notification based on the received multicast group paging message and/or the received RAN multicast group paging message. Further, the group paging controller performs the multicast group paging for one or more determined UE, where the NG-RAN node pages the MBS multicast session activation notification to one or more determined UE based on the determined one or more PO.

Accordingly, the embodiments herein provide the AMF node for performing the multicast group paging for the MBS multicast session activation notification in the wireless network. The AMF node includes a group paging controller coupled with a processor and a memory. The group paging controller receives an MBS session notification request from a SMF node. Further, the group paging controller sends the multicast group paging message to the NG-RAN node upon receiving the MBS session notification request.

Accordingly, the embodiments herein provide the gNB-DU node for performing the multicast group paging for the MBS multicast session activation notification in the wireless network. The gNB-DU node includes a group paging controller coupled with a processor and a memory. The group paging controller receives the multicast group paging message from the gNB-CU node. Further, the group paging controller determines one or more UE that has to be paged for the MBS multicast session activation notification based on the received multicast group paging message. Further, the group paging controller determines one or more PO to send the page for the MBS multicast session activation notification based on the received multicast group paging message. Further, the group paging controller performs the multicast group paging for one or more determined UE, where the gNB-DU node pages the MBS multicast session activation notification to one or more determined UE based on the determined one or more PO.

Accordingly, the embodiments herein provide the UE node for performing the multicast group paging for the MBS multicast session activation notification in the wireless network The UE includes a group paging controller coupled with a processor and a memory. The group paging controller receives the MBS multicast session activation notification from the NG-RAN node and/or the gNB-DU node, where the UE operates in the RRC idle state or the RRC inactive state. Further, the group paging controller initiates the RRC setup request and/or the RRC resume request to transition to the RRC connected state from the RRC idle state or the RRC inactive state to activate the MBS multicast session upon receiving the MBS multicast session activation notification. Further, the group paging controller activates the MBS multicast session to start or resume one or more multicast service in the wireless network.

In an embodiment, the NG-RAN node sends the multicast group paging to one or more determined UE for the MBS multicast session activation notification for all POs or the multicast group paging to one or more determined UE for the MBS multicast session activation notification for relevant POs for one or more UE with a non-activated MBS multicast session, wherein the relevant POs are determined based on the received UE identity index value in the multicast group paging. Sending the MBS multicast session activation notification for all POs or the relevant POs is based on at least one factor of number of UEs to be paged in a cell, a paging resource availability with the NG-RAN node, and a specified group paging behaviour of the NG-RAN node or a capability of the NG-RAN node.

In an embodiment, the second NG-RAN node sends the multicast group paging to one or more determined UE for the MBS multicast session activation notification for all POs or the multicast group paging to one or more determined UE for the MBS multicast session activation notification for relevant POs for one or more UE with a non-activated MBS multicast session, wherein the relevant POs are determined based on the received UE identity index value in the RAN multicast group paging.

In an embodiment, one or more UE (100) operates in a Radio Resource Control (RRC) idle state or an RRC inactive state with a non-activated MBS multicast session as indicated by an MBS session identity (ID) in the multicast group paging message.

The multicast group paging message includes a message type, an MBS session Identity (ID), an MBS service area, a multicast group paging area list, a multicast group paging area item, a multicast group paging area, a UE paging list, a UE paging item, a UE identity index value, a paging Discontinuous Reception (DRX) including one or more a UE specific DRX parameter and a common DRX parameter.

The RAN multicast group paging message includes a message type, an MBS session Identity (ID), a UE identity index list, a UE identity index item, the UE identity index value, an index length, a paging Discontinuous Reception (DRX) including one or more the UE specific DRX parameter and the common DRX parameter, and a multicast RAN paging area.

Unlike existing methods and systems, the proposed method performs the multicast group paging for the MBS multicast session activation notification in the wireless network by sending the multicast group paging message. The multicast group paging message is used to carry the UE identity index value to enable network nodes to identify UEs that need to be paged for multicast session activation. As a result, the UEs know about a status of the multicast session activation and return to the RRC connected state from the RRC idle state or the RRC inactive state to resume the multicast session.

Unlike existing methods and systems, the proposed method performs the multicast group paging for the MBS multicast session activation notification in the wireless network. The method includes a multicast group paging procedure and a message to enable the AMF node to notify the UEs for CM-idle UEs, as newly mentioned in 3GPP TS 38.413 v17.0.0 clauses 8.5.2 and 9.2.4.2.

Unlike existing methods and systems, the proposed method performs the multicast group paging for the MBS multicast session activation notification in the wireless network. The method includes the RAN multicast group paging procedure and a message to enable the gNodeB (gNB) to request paging of the UEs to other gNBs, as newly mentioned in 3GPP TS 38.423 v17.0.0 clauses 8.2.11 and 9.1.1.15.

Unlike existing methods and systems, the proposed method performs the multicast group paging for the MBS multicast session activation notification in the wireless network. The method includes the multicast group paging procedure and a message on an F1 interface (gNB-CU to gNB-DU) to enable the gNB-DU to the multicast group page for the UEs, as newly mentioned in 3GPP TS 38.423 v17.0.0 clauses 8.14.5 and 9.2.14.1.

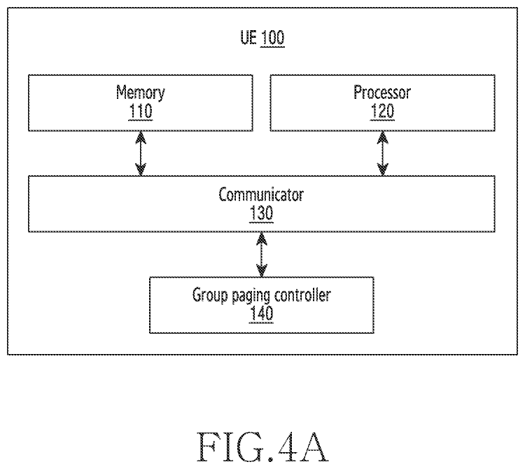

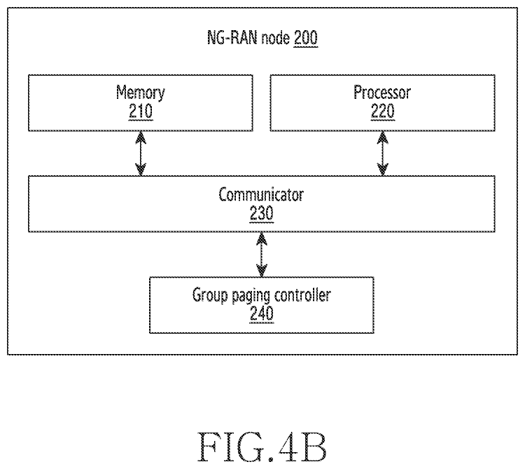

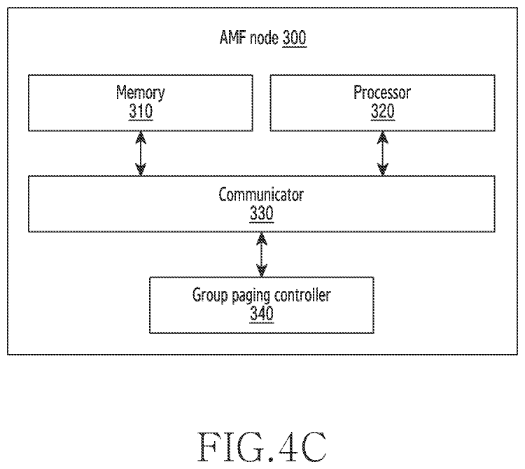

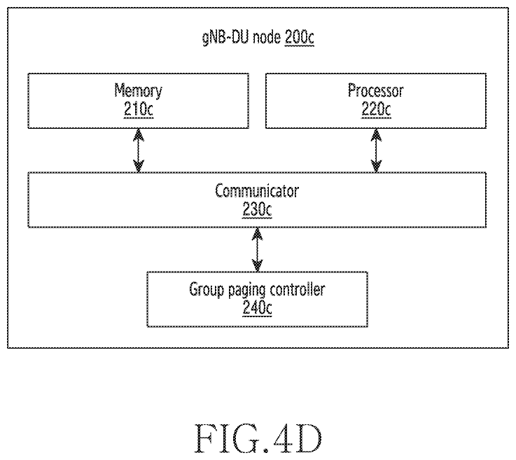

Referring now to the drawings and more particularly to FIGS. 4A to 4D, 5A to 5C, 6A, 6B, 7 to 9, 10A, 10B, 11, and 12, where similar reference characters denote corresponding features consistently throughout the figures, there are shown preferred embodiments.

FIG. 4A illustrates a block diagram of a UE (100) for performing multicast group paging for an MBS multicast session activation notification in a wireless network, according to an embodiment of the disclosure. Examples of the UE (100) include, but not limited to a smartphone, a tablet computer, a Personal Digital Assistance (PDA), an Internet of Things (IoT) device, a wearable device, etc.

In an embodiment, the UE (100) includes a memory (110), a processor (120), a communicator (130), and a group paging controller (140).

In an embodiment, the memory (110) stores a multicast group paging message and a Radio Access Network (RAN) multicast group paging message. The memory (110) stores instructions to be executed by the processor (120). The memory (110) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (110) may, in some examples, be considered a non-transitory storage medium. The term “non-transitory” may indicate that the storage medium is not embodied in a carrier wave or a propagated signal. However, the term “non-transitory” should not be interpreted that the memory (110) is non-movable. In some examples, the memory (110) can be configured to store larger amounts of information than the memory. In certain examples, a non-transitory storage medium may store data that can, over time, change (e.g., in Random Access Memory (RAM) or cache). The memory (110) can be an internal storage unit or it can be an external storage unit of the UE (100), a cloud storage, or any other type of external storage.

The processor (120) communicates with the memory (110), the communicator (130), and the group paging controller (140). The processor (120) is configured to execute instructions stored in the memory (110) and to perform various processes. The processor (120) may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (130) is configured for communicating internally between internal hardware components and with external devices (e.g. a Next Generation Radio Access Network (NG-RAN) node (200) (not shown in FIG. 4A) and a gNodeB Distributed Unit (gNB-DU) node (200c) (not shown in FIG. 4A), server, etc.) via one or more networks (e.g. Radio technology). The communicator (130) includes an electronic circuit specific to a standard that enables wired or wireless communication.

The group paging controller (140) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

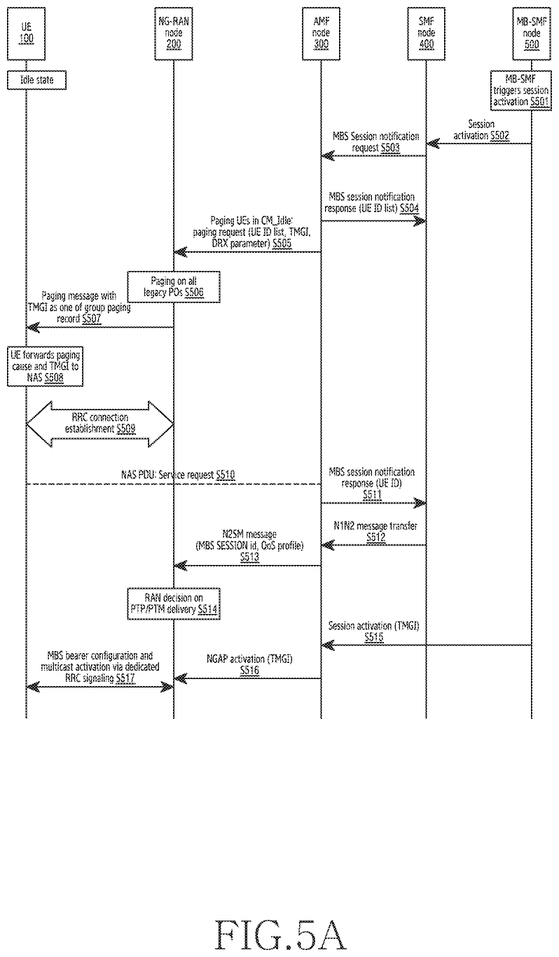

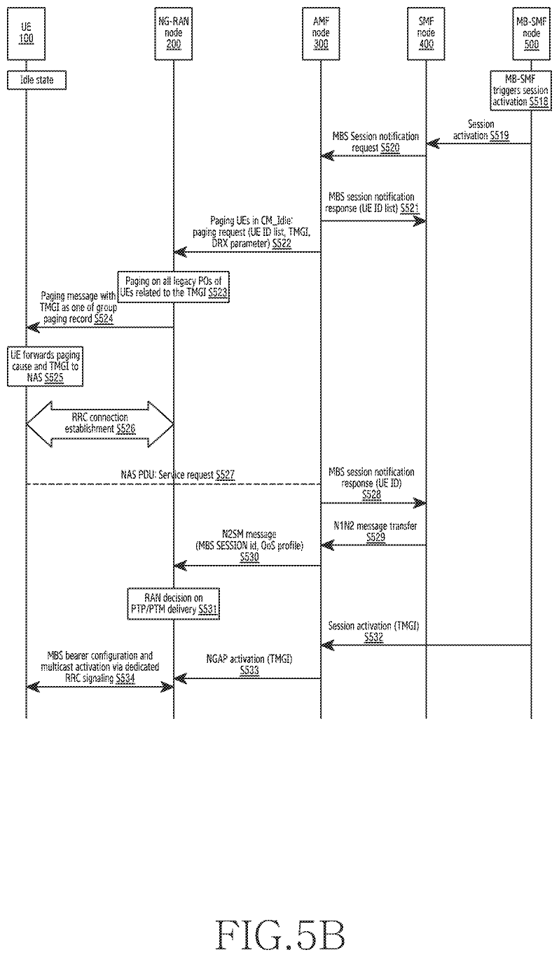

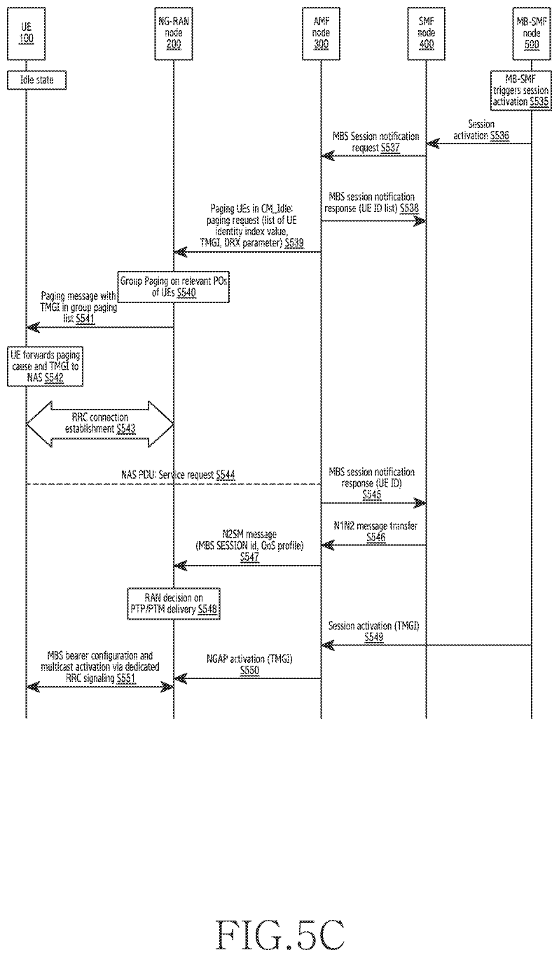

In an embodiment, the group paging controller (140) receives an MBS multicast session activation notification and/or the RAN multicast group paging message from the NG-RAN node (200) and/or the gNB-DU node (200c), where the UE (100) operates in a Radio Resource Control (RRC) idle state or an RRC inactive state. The group paging controller (140) initiates an RRC setup request and/or an RRC resume request to transition to an RRC connected state from the RRC idle state or the RRC inactive state to activate an MBS multicast session upon receiving the MBS multicast session activation notification. The group paging controller (140) activates the MBS multicast session to start or resume one or more multicast service in the wireless network. Further, FIGS. 5A to 5C, 6A, 6B, 7 to 9, 10A, 10B, 11, and 12 show the detailed functionality of the UE (100).

Although the FIG. 4A shows various hardware components of the UE (100) but it is to be understood that other embodiments are not limited thereon. In other embodiments, the UE (100) may include less or more number of components. Further, the labels or names of the components are used only for illustrative purpose and does not limit the scope of the disclosure. One or more components can be combined together to perform same or substantially similar function to activate the MBS multicast session to start or resume one or more multicast service in the wireless network.

FIG. 4B illustrates a block diagram of the NG-RAN node (200) for performing the multicast group paging for the MBS multicast session activation notification in the wireless network, according to an embodiment of the disclosure. Examples of the NG-RAN node (200) include, but are not limited to a gNB, a base station, etc.

In an embodiment, the NG-RAN node (200) includes a memory (210), a processor (220), a communicator (230), and a group paging controller (240).

In an embodiment, the memory (210) stores the multicast group paging message and the RAN multicast group paging message. The memory (210) stores instructions to be executed by the processor (220). The memory (210) may include non-volatile storage elements. Examples of such non-volatile storage elements may include magnetic hard discs, optical discs, floppy discs, flash memories, or forms of EPROM or EEPROM memories. In addition, the memory (210) may, in some examples, be considered a non-transitory storage medium. The term “non-transitory” may indicate that the storage medium is not embodied in a carrier wave or a propagated signal. However, the term “non-transitory” should not be interpreted that the memory (210) is non-movable. In some examples, the memory (210) can be configured to store larger amounts of information than the memory. In certain examples, a non-transitory storage medium may store data that can, over time, change (e.g., in RAM or cache). The memory (210) can be an internal storage unit or it can be an external storage unit of the NG-RAN node (200), a cloud storage, or any other type of external storage.

The processor (220) communicates with the memory (210), the communicator (230), and the group paging controller (240). The processor (220) is configured to execute instructions stored in the memory (210) and to perform various processes. The processor (220) may include one or a plurality of processors, maybe a general-purpose processor, such as the CPU, the AP, or the like, a graphics-only processing unit such as the GPU, the VPU, and/or the AI dedicated processor such as the NPU.

The communicator (230) is configured for communicating internally between internal hardware components and with external devices (e.g. the gNB-DU node (200c), the UE (100) (not shown in FIG. 4B), server, etc.) via one or more networks (e.g. Radio technology). The communicator (230) includes an electronic circuit specific to a standard that enables wired or wireless communication.

The group paging controller (240) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the group paging controller (240) receives the multicast group paging message from an Access and Mobility Management Function (AMF) node (300). The multicast group paging message includes a message type, an MBS session identity (ID), an MBS service area, a multicast group paging area list, a multicast group paging area item, a multicast group paging area, a UE paging list, a UE paging item, a UE identity index value, and a paging Discontinuous reception (DRX) including one or more a UE specific DRX parameter and a common DRX parameter. Further, the group paging controller (240) determines one or more UE (100) that has to be paged for the MBS multicast session activation notification based on the received multicast group paging message. One or more UE (100) operates in the RRC idle state or the RRC inactive state with the non-activated MBS multicast session. Further, the group paging controller (240) determines one or more Paging Occasion (PO) to send the page for the MBS multicast session activation notification based on the received multicast group paging message.

Further, the group paging controller (240) performs the multicast group paging for one or more determined UE (100), where the NG-RAN node (200) pages the MBS multicast session activation notification to one or more determined UE (100) based on the determined one or more PO. The group paging controller (240) sends the multicast group paging to one or more determined UE (100) for the MBS multicast session activation notification for all POs or sends the multicast group paging to one or more determined UE (100) for the MBS multicast session activation notification for relevant POs for one or more UE (100) with a non-activated MBS multicast session, where the relevant POs are determined based on the received UE identity index value in the multicast group paging. Sending the MBS multicast session activation notification for all POs or the relevant POs is based on one or more factor, such as a number of UEs (100) to be paged in a cell, a paging resource availability with the NG-RAN node (200), and a specified group paging behaviour of the NG-RAN node (200) or a capability of the NG-RAN node (200).

Further, the group paging controller (240) receives the RAN multicast group paging message from other NG-RAN node (e.g., first NG-RAN node (200a)). The RAN multicast group paging message includes a message type, an MBS session identity (ID), a UE identity index list, a UE identity index item, a UE identity index value, an index length, a paging Discontinuous reception (DRX) including one or more a UE specific DRX parameter and a common DRX parameter, and multicast RAN paging area. The group paging controller (240) determines one or more UE (100) that has to be paged for the MBS multicast session activation notification based on the received RAN multicast group paging message. The group paging controller (240) determines one or more PO to send the page for the MBS multicast session activation notification based on the received RAN multicast group paging message. The group paging controller (240) performs the multicast group paging for one or more determined UE (100), where the NG-RAN node (200) pages the MBS multicast session activation notification to one or more determined UE (100) based on the determined one or more PO. Further, FIG. 5A to 5C, 6A, 6B, 7 to 9, 10A, 10B, 11, and 12 show the detailed functionality of the NG-RAN node (200).

Although the FIG. 4B shows various hardware components of the NG-RAN node (200) but it is to be understood that other embodiments are not limited thereon. In other embodiments, the NG-RAN node (200) may include less or more number of components. Further, the labels or names of the components are used only for illustrative purpose and does not limit the scope of the disclosure. One or more components can be combined together to perform same or substantially similar function to perform the multicast group paging for the MBS multicast session activation notification in the wireless network.

FIG. 4C illustrates a block diagram of the AMF node (300) for performing the multicast group paging for the MBS multicast session activation notification in the wireless network, according to an embodiment of the disclosure.

In an embodiment, the AMF node (300) includes a memory (310), a processor (320), a communicator (330), and a group paging controller (340).

In an embodiment, the memory (310) stores the multicast group paging message. The memory (310) stores instructions to be executed by the processor (320). The memory (310) may include non-volatile storage elements. Examples of such non-volatile storage elements may include magnetic hard discs, optical discs, floppy discs, flash memories, or forms of EPROM or EEPROM memories. In addition, the memory (310) may, in some examples, be considered a non-transitory storage medium. The term “non-transitory” may indicate that the storage medium is not embodied in a carrier wave or a propagated signal. However, the term “non-transitory” should not be interpreted that the memory (310) is non-movable. In some examples, the memory (310) can be configured to store larger amounts of information than the memory. In certain examples, a non-transitory storage medium may store data that can, over time, change (e.g., in RAM or cache). The memory (310) can be an internal storage unit or it can be an external storage unit of the AMF node (300), a cloud storage, or any other type of external storage.

The processor (320) communicates with the memory (310), the communicator (330), and the group paging controller (340). The processor (320) is configured to execute instructions stored in the memory (310) and to perform various processes. The processor (320) may include one or a plurality of processors, maybe a general-purpose processor, such as the CPU, the AP, or the like, a graphics-only processing unit such as the GPU, the VPU, and/or the AI dedicated processor such as the NPU.

The communicator (330) is configured for communicating internally between internal hardware components and with external devices (e.g. the gNB-DU node (200c), the UE (100) (not shown in FIG. 4C), server, etc.) via one or more networks (e.g. Radio technology). The communicator (330) includes an electronic circuit specific to a standard that enables wired or wireless communication.

The group paging controller (340) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the group paging controller (340) receives an MBS session notification request from a SMF node (400). The group paging controller (340) sends an MBS notification response to the SMF node (400) upon receiving the MBS session notification request. Then, the group paging controller (340) sends the multicast group paging message to the NG-RAN node (200). Further, FIGS. 5A to 5C, 6A, 6B, 7 to 9, 10A, 10B, 11, and 12 show the detailed functionality of the AMF node (300).

Although the FIG. 4C shows various hardware components of the AMF node (300) but it is to be understood that other embodiments are not limited thereon. In other embodiments, the AMF node (300) may include less or more number of components. Further, the labels or names of the components are used only for illustrative purpose and does not limit the scope of the disclosure. One or more components can be combined together to perform same or substantially similar function to perform the multicast group paging for the MBS multicast session activation notification in the wireless network.

FIG. 4D illustrates a block diagram of the gNB-DU node (200c) for performing the multicast group paging for the MBS multicast session activation notification in the wireless network, according to an embodiment of the disclosure.

In an embodiment, the gNB-DU node (200c) includes a memory (210c), a processor (220c), a communicator (230c), and a group paging controller (240c).

In an embodiment, the memory (210c) stores the multicast group paging message. The memory (210c) stores instructions to be executed by the processor (220c). The memory (210c) may include non-volatile storage elements. Examples of such non-volatile storage elements may include magnetic hard discs, optical discs, floppy discs, flash memories, or forms of EPROM or EEPROM memories. In addition, the memory (210c) may, in some examples, be considered a non-transitory storage medium. The term “non-transitory” may indicate that the storage medium is not embodied in a carrier wave or a propagated signal. However, the term “non-transitory” should not be interpreted that the memory (210c) is non-movable. In some examples, the memory (210c) can be configured to store larger amounts of information than the memory. In certain examples, a non-transitory storage medium may store data that can, over time, change (e.g., in RAM or cache). The memory (210c) can be an internal storage unit or it can be an external storage unit of the gNB-DU node (200c), a cloud storage, or any other type of external storage.

The processor (220c) communicates with the memory (210c), the communicator (230c), and the group paging controller (240c). The processor (220c) is configured to execute instructions stored in the memory (210c) and to perform various processes. The processor (220c) may include one or a plurality of processors, maybe a general-purpose processor, such as the CPU, the AP, or the like, a graphics-only processing unit such as the GPU, the VPU, and/or the AI dedicated processor such as the NPU.

The communicator (230c) is configured for communicating internally between internal hardware components and with external devices (e.g. the UE (100) (not shown in FIG. 4D), server, etc.) via one or more networks (e.g. Radio technology). The communicator (230c) includes an electronic circuit specific to a standard that enables wired or wireless communication.

The group paging controller (240c) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the group paging controller (240c) receives the multicast group paging message from a gNodeB Centralized Unit (gNB-CU) node (200d). The multicast group paging message includes a message type, an MBS session identity (ID), a UE identity list for paging, a UE identity for paging item, a UE identity index value, a paging Discontinuous reception (DRX) including one or more a UE specific DRX parameter and a common DRX parameter, a paging cell list, and a paging cell item. The group paging controller (240c) determines one or more UE (100) that has to be paged for the MBS multicast session activation notification based on the received multicast group paging message. The group paging controller (240c) determines one or more PO to send the page for the MBS multicast session activation notification based on the received multicast group paging message. The group paging controller (240c) performs the multicast group paging for one or more determined UE (100), where the gNB-DU node (200c) pages the MBS multicast session activation notification to one or more determined UE (100) based on the determined one or more PO.

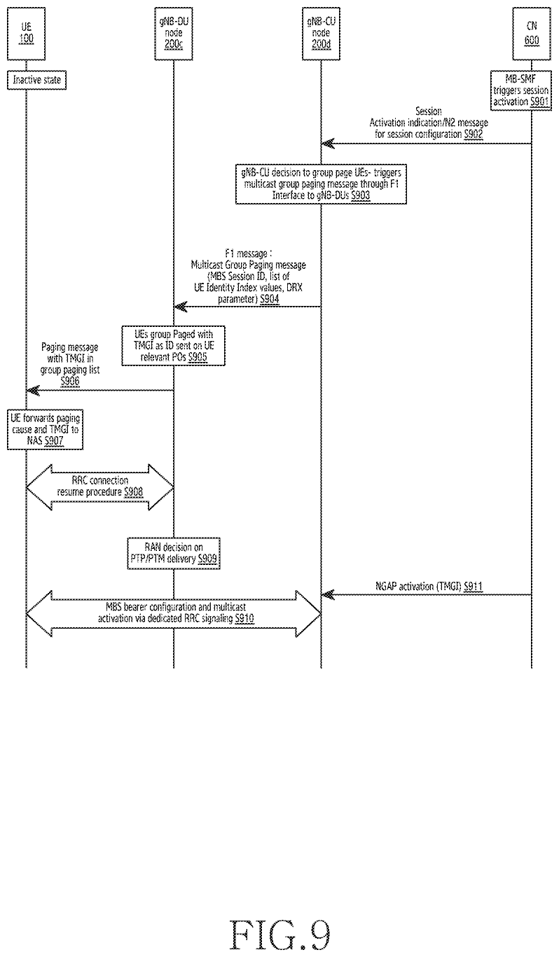

Further, the group paging controller (240c) performs the multicast group paging for one or more determined UE (100), where the NG-RAN node (200) pages the MBS multicast session activation notification to one or more determined UE (100) based on the determined one or more PO. The group paging controller (240c) sends the multicast group paging to one or more determined UE (100) for the MBS multicast session activation notification for all POs or sends the multicast group paging to one or more determined UE (100) for the MBS multicast session activation notification for relevant POs for one or more UE (100) with a non-activated MBS multicast session, where the relevant POs are determined based on the received UE identity index value in the multicast group paging. Sending the MBS multicast session activation notification for all POs or the relevant POs is based on one or more factor, such as a number of UEs (100) to be paged in a cell, a paging resource availability with the NG-RAN node (200), and a specified group paging behaviour of the NG-RAN node (200) or a capability of the NG-RAN node (200). Further, FIG. 9 show the detailed functionality of the gNB-DU node (200c).

Although the FIG. 4D shows various hardware components of the gNB-DU node (200c) but it is to be understood that other embodiments are not limited thereon. In other embodiments, the gNB-DU node (200c) may include less or more number of components. Further, the labels or names of the components are used only for illustrative purpose and does not limit the scope of the disclosure. One or more components can be combined together to perform same or substantially similar function to perform the multicast group paging for the MBS multicast session activation notification in the wireless network.

Paging resource efficiency: In an embodiment, the paging mechanism is used for the MBS multicast session activation notification. However, considering a UE impact, paging for the MBS needs to coexist on legacy paging occasions. That is, effectively, paging for the MBS is provided as an extension of the paging message used for legacy purposes. Paging for the MBS impacts a paging capacity of the legacy unicast services. Further, there can be two approaches to do paging for the MBS multicast session activation notification.

Approach-1: Paging for the MBS multicast session activation notification is used in all legacy Paging Occasions (POs).

Approach-2: Paging for the MBS multicast session activation notification is used in relevant POs for the UEs (100a-100n) with the non-activated multicast session(s).

With approach-2, there is enhanced paging resource efficiency. Paging for the MBS multicast session activation notification will be limited to specific (relevant) paging occasions for the UEs (100a-100n) which had non-activated MBS multicast session(s). The non-activated multicast session can correspond to the session which is configured or joined but it is not yet activated or it is deactivated after it was activated.

Moreover, these relevant POs will carry only paging records for the relevant activated TMGIs for the UEs (100a-100n) pertinent to paging occasions. As compared to approach-1 where each legacy POs needs to carry paging records for all the TMGIs which are activated. Therefore, there are two-fold advantages with paging resource efficiency with approach-2.

In an embodiment, the NG-RAN node (200) may have different capabilities, user densities, and paging resources support, and therefore, the NG-RAN node (200) can determine to statistically/semi-statistically or dynamically choose between the approach-1 and the approach-2. Further, the network entity can broadcast or signal in the configuration of the supported approach to the UE (100). Further, this can also be signalled across RAN nodes (200) (i.e. between the gNBs or base stations) and across RAN node(s) and CN (Core Network) node(s) (e.g. between the gNB and the AMF node (300)). For instance, the NG-RAN node (200) may report MBS capability to the AMF node (300) in the NGAP setup procedure e.g. MBS or non-MBS capability, preference for all legacy POs or relevant POs for the UEs (100a-100n) with non-activated session or both, any other information related to a user density, a paging configuration, a UE state, a UE DRX configuration, a common DRX, a UE specific DRX and so on.

In an embodiment, the UE (100) which missed notification at a paging occasion due to decoding issue or temporary service/coverage loss or other reasons, can re-attempt paging decode in any other paging occasion when the approach-1 is deployed.

FIG. 5A illustrates a sequence diagram for sending the multicast session activation notification for the UE(s) in the RRC idle state using group paging on all legacy paging occasions, according to an embodiment of the disclosure.

At operation S501, the MB-SMF node (500) triggers session (e.g., MBS session) activation, where the session activation may be triggered by the following events,

When the MB-UPF (not shown in FIG. 5A) receives the downlink data for the MBS session, the MB-UPF sends the MB-N4 notification (N4 Session ID) to the MB-SMF node (500) for activating the MBS session.

The AF (not shown in FIG. 5A) sends the MBS activation request (TMGI) to the MB-SMF node (500) directly or via the NEF ((not shown in FIG. 5A)).

At operation S502, the MB-SMF node (500) sends the session activation notification (TMGI) to one or more SMF nodes (400). Based on the received TMGI, the SMF node (400) finds a list of UEs (100a-100n) that joined the MBS session identified by the TMGI. If the SMF node (400) determines a user plane of an associated PDU session(s) of the UEs (100a-100n) with respect to the TMGI are activated already, operations S503-S508 will be skipped for the UE (100).

At operation S503, the SMF node (400) sends the MBS session notification request to the AMF node (300), including (the UE list, and TMGI). After receiving the MBS session notification request, for each UE (100) in the list, the AMF node (300) determines the CM state of the UE (100), as given in operations S504-S507. At operation S504, if the UE (100) involved in the MBS session operates in the CM-connected state, the AMF node (300) responds to the list of the UE (100) involved in the MBS Session and in the CM-connected state, using the MBS session notification response (UE ID list). Operations S505-S506 will not be executed for that UEs (100a-100n) in the list.

At operation S505, if the AMF node (300) determines that there are any UEs (100a-100n) in the CM-IDLE state (i.e. RRC_IDLE) and involved in the MBS Session, and the AMF node (300) figures out the paging area considering all the UEs (100), which need to be paged. The AMF node (300) sends the paging request message (UE ID list, TMGI, DRX parameter) to the NG-RAN node(s) (e.g., one or more RAN (200)) belonging to the paging area with the TMGI as the identifier to be paged if the related NG-RAN node (200) support the MBS session. At operations S506-S507, after receiving the paging request, the NG-RAN node (200) initiates the paging procedure for sending CN paging for the UEs (100a-100n) in the list, where the NG-RAN node (200) sends the CN paging through group paging message with the paging identifier set to TMGI of the session to be activated in all the legacy POs.

At operations S508-S509, the UE (100) forwards the paging cause and the TMGI to the NAS and established the RRC connection with the NG-RAN node (200). At operation S510, the UE (100) operates in the IDLE state and sends the service request to the AMF node (300). At operation S511, after receiving the service request sent by the UE (100), the AMF node (300) responds to the SMF node (400) with the MBS session notification response (UE ID). At operations S512-S513, after receiving the MBS session notification response, the SMF node (400) determines the related UE (100) operates in the CM-connected state and sends the Namf_Communication_N1N2 message transfer (e.g., N2 SM message (MBS Session identifier, associated QoS profiles) to the NG-RAN node (200) via the AMF node (300) for the UE (100) which is identified in operation S503. The AMF node (300) sends the N2 request message (e.g., N2 SM message (MBS Session identifier, associated QoS profiles) to the NG-RAN node (200).

At operation S514, after receiving the N2 message, the NG-RAN node (200) decides on PTP/PTM delivery. If the shared tunnel has not been established before, the shared tunnel is established at this step. In addition, the NG-RAN node (200) responds to the SMF node (400). The NG-RAN node (200) configures the UE (100) with the RRC messages if needed. At operation S515, the MB-SMF node (500) sends the session activation (TMGI) to the AMF node (300). At operations S516-S517, the AMF node (300) sends the NGAP activation message (TMGI) to the NG-RAN node (200). After receiving the NGAP activation message, the NG-RAN node (200) determines the RRC state of the related UE (100), configures the MBS bearer, and sends the multicast activation via the dedicated RRC signalling.

FIG. 5B illustrates a sequence diagram for sending the multicast session activation notification for the UEs (100a-100n) in the RRC idle state using the group paging on relevant paging occasions for the UEs (100a-100n) with the non-activated multicast session(s), according to an embodiment of the disclosure.

At operation S518, the MB-SMF node (500) triggers session (e.g., MBS session) activation, where the session activation may be triggered by the following events,

When the MB-UPF (not shown in FIG. 5B) receives the downlink data for the MBS session, the MB-UPF sends the MB-N4 notification (N4 Session ID) to the MB-SMF node (500) for activating the MBS session.

The AF (not shown in FIG. 5B) sends the MBS activation request (TMGI) to the MB-SMF node (500) directly or via the NEF ((not shown in FIG. 5B)).

At operation S519, the MB-SMF node (500) sends the session activation notification (TMGI) to one or more SMF nodes (400). Based on the received TMGI, the SMF node (400) finds the list of UEs (100a-100n) that joined the MBS session identified by the TMGI. If the SMF node (400) determines the user plane of an associated PDU session(s) of the UEs (100a-100n) with respect to the TMGI are activated already, operations S520-S525 will be skipped for the UE (100).

At operation S520, the SMF node (400) sends the MBS session notification request to the AMF node (300), including (the UE list, and TMGI). After receiving the MBS session notification request, for each UE (100) in the list, the AMF node (300) determines the CM state of the UE (100), as given in operations S521-S524. At operation S521, if the UE (100) involved in the MBS session operates in the CM-connected state, the AMF node (300) responds to the list of the UE (100) involved in the MBS Session and the CM-connected state, using the MBS session notification response (UE ID list). Operations S522-S523 will not be executed for that UEs (100a-100n) in the list.

At operation S522, if the AMF node (300) determines that there are any UEs (100a-100n) in the CM-IDLE state (i.e. RRC_IDLE) and involved in the MBS Session, and the AMF node (300) figures out the paging area considering all the UEs (100), which need to be paged. The AMF node (300) sends the paging request message (UE ID list, TMGI, DRX parameter) to the NG-RAN node(s) (e.g., one or more RAN (200)) belonging to the paging area with the TMGI as the identifier to be paged if the related NG-RAN node (200) support the MBS session. At operations S523-S524, after receiving the paging request, the NG-RAN node (200) initiates the paging procedure for sending CN paging for the UEs (100a-100n) in the list, where the NG-RAN node (200) sends the CN paging through group paging message with the paging identifier set to TMGI of the session to be activated in the relevant Paging occasions for the UEs (100a-100n) with non-activated sessions alone.

At operations S525-S526, the UE (100) forwards the paging cause and the TMGI to the NAS and established the RRC connection with the NG-RAN node (200). At operation S527, the UE (100) operates in the IDLE state and sends the service request to the AMF node (300). At operation S528, after receiving the service request sent by the UE (100), the AMF node (300) responds to the SMF node (400) with the MBS session notification response (UE ID). At operations S529-S530, after receiving MBS session notification response, the SMF node (400) determines the related UE (100) operates in the CM-connected state and sends the Namf_Communication_N1N2 message transfer (e.g., N2 SM message (MBS Session identifier, associated QoS profiles) to the NG-RAN node (200) via the AMF node (300) for the UE (100) which is identified in operation S503. The AMF node (300) sends the N2 request message (e.g., N2 SM message (MBS Session identifier, associated QoS profiles) to the NG-RAN node (200).

At operation S531, after receiving the N2 message, the NG-RAN node (200) takes the decision on PTP/PTM delivery. If the shared tunnel has not been established before, the shared tunnel is established at this step. In addition, the NG-RAN node (200) responds to the SMF node (400). The NG-RAN node (200) configures the UE (100) with the RRC messages if needed.

At operation S532, the MB-SMF node (500) sends the session activation (TMGI) to the AMF node (300). At operations S533-S534, the AMF node (300) sends the NGAP activation message (TMGI) to the NG-RAN node (200). After receiving the NGAP activation message, the NG-RAN node (200) determines the RRC state of the related UE (100), configures the MBS bearer, and sends the multicast activation via the dedicated RRC signalling.

FIG. 5C illustrates a sequence diagram for sending the multicast session activation notification for the UEs (100a-100n) in the RRC idle state using the group paging on relevant paging occasions for the UEs (100a-100n) with the non-activated multicast session(s), according to an embodiment of the disclosure.

At operation S535, the MB-SMF node (500) triggers session (e.g., MBS session) activation, where the session activation may be triggered by the following events,

When the MB-UPF (not shown in FIG. 5C) receives the downlink data for the MBS session, the MB-UPF sends the MB-N4 notification (N4 Session ID) to the MB-SMF node (500) for activating the MBS session.

The AF (not shown in FIG. 5C) sends the MBS activation request (TMGI) to the MB-SMF node (500) directly or via the NEF ((not shown in FIG. 5C)).

At operation S536, the MB-SMF node (500) sends the session activation notification to one or more SMF nodes (400). Based on the received TMGI, the SMF node (400) finds the list of UEs (100a-100n) that joined the MBS session identified by the TMGI. If the SMF node (400) determines the user plane of an associated PDU session(s) of the UEs (100a-100n) with respect to the TMGI are activated already, operations S537-S542 will be skipped for the UE (100).

At operation S537, the SMF node (400) sends the MBS session notification request to the AMF node (300). After receiving the MBS session notification request, for each UE (100) in the list, the AMF node (300) determines the CM state of the UE (100), as given in operations S521-S524. At operation S538, if the UE (100) involved in the MBS session operates in the CM-connected state, the AMF node (300) responds to the list of the UE (100) involved in the MBS Session and the CM-connected state, using the MBS session notification response (UE ID list). Operations S539-S540 will not be executed for that UEs (100a-100n) in the list.

At operation S539, if the AMF node (300) determines that there are any UEs (100a-100n) in the CM-IDLE state (i.e. RRC_IDLE) and involved in the MBS Session, and the AMF node (300) figures out the paging area considering all the UEs (100), which need to be paged. The AMF node (300) sends the paging request message (list of UE identity index value, TMGI, DRX parameter) (i.e. multicast group paging message) to the NG-RAN node(s) (e.g., one or more RAN (200)) belonging to the paging area with the TMGI as the identifier to be paged if the related NG-RAN node (200) support the MBS session. At operations S540-S541, after receiving the paging request, the NG-RAN node (200) initiates the paging procedure for sending CN paging for the UEs (100a-100n) in the list, where the NG-RAN node (200) sends the CN paging through group paging message with the paging identifier set to TMGI of the session to be activated in the relevant POs for the UEs (100a-100n) with non-activated sessions alone as determined by the UE identity index value received in the multicast group paging message.

At operations S542-S543, the UE (100) forwards the paging cause and the TMGI to the NAS and established the RRC connection with the NG-RAN node (200). At operation S544, the UE (100) operates in the IDLE state and sends the service request to the AMF node (300). At operation S545, after receiving the service request sent by the UE (100), the AMF node (300) responds to the SMF node (400) with the MBS session notification response (UE ID). At operations S546-S547, after receiving the MBS session notification response, the SMF node (400) determines the related UE (100) operates in the CM-connected state and sends the Namf_Communication_N1N2 message transfer (e.g., N2 SM message (MBS Session identifier, associated QoS profiles) to the NG-RAN node (200) via the AMF node (300) for the UE (100) which is identified in operation S503. The AMF node (300) sends the N2 request message (e.g., N2 SM message (MBS Session identifier, associated QoS profiles) to the NG-RAN node (200).

At operation S548, after receiving the N2 message, the NG-RAN node (200) takes the decision on PTP/PTM delivery. If the shared tunnel has not been established before, the shared tunnel is established at this step. In addition, the NG-RAN node (200) responds to the SMF node (400). The NG-RAN node (200) configures the UE (100) with the RRC messages if needed.

At operation S549, the MB-SMF node (500) sends the session activation (TMGI) to the AMF node (300). At operations S550-S551, the AMF node (300) sends the NGAP activation message (TMGI) to the NG-RAN node (200). After receiving the NGAP activation message, the NG-RAN node (200) determines the RRC state of the related UE (100), configures the MBS bearer, and sends the multicast activation via the dedicated RRC signalling.

The following Table-2 shows an example of the multicast group paging message format that was transmitted by the AMF node (300) to the NG-RAN node

TABLE 2

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | ignore |
| MBS Session ID | M | | 9.3.1.206 | | YES | ignore |
| MBS Service | O | | 9.3.1.208 | | YES | ignore |
| Area | | | | | | |
| Multicast Group | M | | | | YES | ignore |
| Paging Area List | | | | | | |
| Multicast | | 1 . . . | | | — | |
| Group Paging | | <maxnoofPagingAreas> | | | | |
| Area Item | | | | | | |
| >>Multicast | M | | 9.3.1.216 | | — | |
| Group Paging | | | | | | |
| Area | | | | | | |
| >>UE Paging | | 0 . . . 1 | | | — | |
| List | | | | | | |
| >>>UE | | 1 . . . | | | — | |
| Paging Item | | <maxnoofUEsforPaging> | | | | |
| >>>>UE | M | | 9.3.3.23 | | — | |
| Identity | | | | | | |
| Index Value | | | | | | |
| >>>>Paging | O | | 9.3.1.90 | | — | |
| DRX | | | | | | |

Alternatively, in an embodiment, when the AMF node (300) sends the paging message (i.e. multicast group paging message, refer to Table-2) to the NG-RAN node (200), it includes, in the paging message, the UE identity index value, to identify the UEs (100a-100n) that need to be paged, along with the TMGI of the multicast session. According to TS38.304, PO calculation for paging notification uses 5G-S-TMSI mod 1024. Therefore, 5G-S-TMSI mod 1024 used as the UE identity in the NG group paging message is sufficient. After a modular operation, the UE identity can be the same for the different UEs (100a-100n). It is 10 bits long identity. Compared to 5G-S-TMSI (48 bits) for each UE (100), the message size is reduced a lot. Thus, a list of 5G-S-TMSI mod 1024 together with the TMGI operates included in the multicast group paging message sent from the AMF node (300) to the NG-RAN node (200) (e.g., gNB). 5G-S-TMGI mod 1024 has been defined in TS38.413. It is called the UE identity index value. Compared to 5G-S-TMSI, which is 48 bits long, this IE uses only 10 bits and thus reduces the size of the paging message significantly. Further, POs for group notification for these UEs (100a-100n) is determined from the formulation of the UE identity index value.

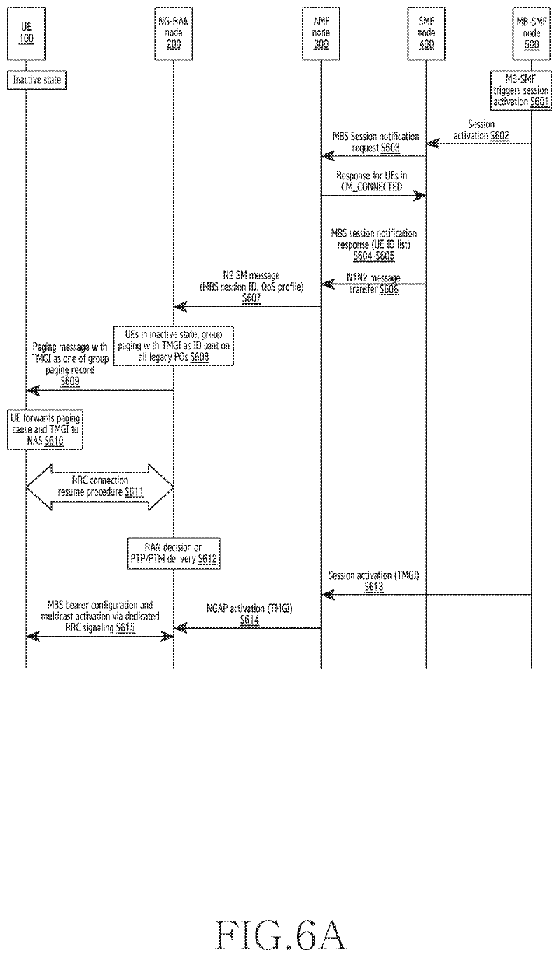

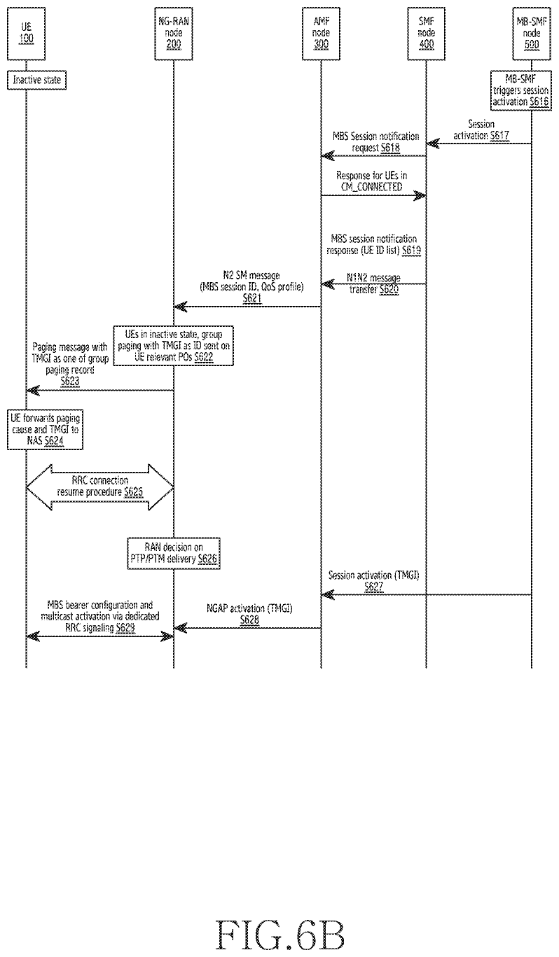

FIG. 6A illustrates a sequence diagram for sending the multicast session activation notification for the UEs (100a-100n) in the RRC inactive state using the group paging on all legacy paging occasions, according to an embodiment of the disclosure.

At operation S601, the MB-SMF node (500) triggers session (e.g., MBS session) activation, where the session activation may be triggered by the following events,

When the MB-UPF (not shown in FIG. 6A) receives downlink data for the MBS session, the MB-UPF sends the MB-N4 notification (N4 Session ID) to the MB-SMF node (500) for activating the MBS session.

The AF (not shown in FIG. 6A) sends the MBS activation request (TMGI) to the MB-SMF node (500) directly or via the NEF ((not shown in FIG. 6A)).

At operation S602, the MB-SMF (35) sends the session activation notification (TMGI) to one or more SMF nodes (400). Based on the received TMGI, the SMF node (400) finds the list of UEs (100a-100n) that joined the MBS session identified by the TMGI. If the SMF node (400) determines the user plane of the associated PDU session(s) of the UEs (100a-100n) with respect to the TMGI are activated already, operations S603-S609 will be skipped for the UE (100).

At operation S603, the SMF node (400) sends the MBS session notification request to the AMF node (300), including (the UE ID list, and TMGI). After receiving the MBS session notification request, for each UE (100) in the list, the AMF (300) determines the CM state of the UE (100), as given in operations S604-S606. At operation S604-S605, if the UE (100) involved in the MBS session operates in the CM-connected state, the AMF node (300) responds to the list of the UE (100) involved in the MBS Session, and the CM-connected state, using the MBS session notification response (UE ID list). Operations S606-S607 will not be executed for that UEs (100a-100n) in the list. At operations S606-S607, after receiving the MBS session notification response, the SMF node (400) determines the related UE (100) operates in the CM-connected state and sends the Namf_Communication_N1N2 message transfer (e.g., N2 SM message (MBS Session identifier, associated QoS profiles) to the NG-RAN node (200) via the AMF node (300) for the UE (100) which is identified in operation S603. The AMF node (300) sends the N2 request message (e.g., N2 SM message (MBS Session identifier, associated QoS profiles) to the NG-RAN node (200).

At operations S608-S609, after receiving the N2 request message, the NG-RAN node (200) initiates the paging procedure for sending CN paging for the UEs (100a-100n) in the list, where the NG-RAN node (200) sends the CN paging through group paging message with the paging identifier set to TMGI as ID of the session to be activated in all the legacy POs.

At operations S610-S611, the UE (100) forwards the paging cause and the TMGI to the NAS and established the RRC connection with the NG-RAN node (200). At operation S612, the NG-RAN node (200) takes the decision on the PTP/PTM delivery. If the shared tunnel has not been established before, the shared tunnel is established at this step. In addition, the NG-RAN node (200) responds to the SMF node (400). The NG-RAN node (200) configures the UE (100) with RRC messages if needed. At operation S613, the MB-SMF node (500) sends the session activation (TMGI) to the AMF node (300). At operations S614-S615, the AMF node (300) sends the NGAP activation message (TMGI) to the NG-RAN node (200). After receiving the NGAP activation message, the NG-RAN node (200) determines the RRC state of the related UE (100), configures the MBS bearer, and sends multicast activation via the dedicated RRC signalling.

FIG. 6B illustrates a sequence diagram for sending the multicast session activation notification for the UEs (100a-100n) in the RRC inactive state using the group paging on the relevant paging occasions for the UEs (100a-100n) with the non-activated multicast session(s), according to an embodiment of the disclosure.

At operation S616, the MB-SMF node (500) triggers session (e.g., MBS session) activation, where the session activation may be triggered by the following events,

When the MB-UPF (not shown in FIG. 6B) receives downlink data for the MBS session, the MB-UPF sends the MB-N4 notification (N4 Session ID) to the MB-SMF node (500) for activating the MBS session.

The AF (not shown in FIG. 6B) sends the MBS activation request (TMGI) to the MB-SMF node (500) directly or via the NEF ((not shown in FIG. 6B)).

At operation S617, the MB-SMF (35) sends the session activation notification (TMGI) to one or more SMF nodes (400). Based on the received TMGI, the SMF node (400) finds the list of UEs (100a-100n) that joined the MBS session identified by the TMGI. If the SMF node (400) determines the user plane of the associated PDU session(s) of the UEs (100a-100n) with respect to the TMGI are activated already, operations S618-S624 will be skipped for the UE (100).

At operation S618, the SMF node (400) sends the MBS session notification request to the AMF node (300), including (the UE ID list, and TMGI). After receiving the MBS session notification request, for each UE (100) in the list, the AMF (300) determines the CM state of the UE (100), as given in operations S619-S621. At operation S619, if the UE (100) involved in the MBS session operates in the CM-connected state, the AMF node (300) responds to the list of the UE (100) involved in the MBS Session and the CM-connected state, using the MBS session notification response (UE ID list). Operations S620-S621 will not be executed for that UEs (100a-100n) in the list. At operations S620-S621, after receiving the MBS session notification response, the SMF node (400) determines the related UE (100) operates in the CM-connected state and sends the Namf_Communication_N1N2 message transfer (e.g., N2 SM message (MBS Session identifier, associated QoS profiles) to the NG-RAN node (200) via the AMF node (300) for the UE (100) which is identified in operation S603. The AMF node (300) sends the N2 request message (e.g., N2 SM message (MBS Session identifier, associated QoS profiles) to the NG-RAN node (200).

At operations S622-S623, after receiving the N2 request message, the NG-RAN node (200) initiates the paging procedure for sending CN paging for the UEs (100a-100n) in the list, where the NG-RAN node (200) sends the CN paging through group paging message with the paging identifier set to TMGI of the session to be activated in the relevant Paging occasions for the UEs (100a-100n) with non-activated sessions alone.

At operations S624-S625, the UE (100) forwards the paging cause and the TMGI to the NAS and established the RRC connection with the NG-RAN node (200). At operation S626, the NG-RAN node (200) takes the decision on the PTP/PTM delivery. If the shared tunnel has not been established before, the shared tunnel is established at this step. In addition, the NG-RAN node (200) responds to the SMF node (400). The NG-RAN node (200) configures the UE (100) with RRC messages if needed. At operation S627, the MB-SMF node (500) sends the session activation (TMGI) to the AMF node (300). At operations S628-S629, the AMF node (300) sends the NGAP activation message (TMGI) to the NG-RAN node (200). After receiving the NGAP activation message, the NG-RAN node (200) determines the RRC state of the related UE (100), configures the MBS bearer, and sends multicast activation via the dedicated RRC signalling.

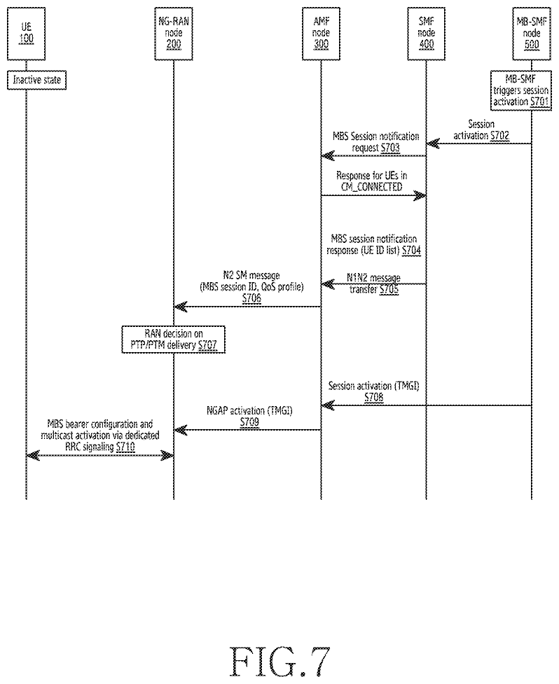

FIG. 7 illustrates a sequence diagram for sending the multicast session activation notification for the UEs (100a-100n) in the RRC connected state using dedicated signalling, according to an embodiment of the disclosure.

At operation S701, the MB-SMF node (500) triggers session (e.g., MBS session) activation, where the session activation may be triggered by the following events,

When the MB-UPF (not shown in FIG. 7) receives downlink data for the MBS session, the MB-UPF sends the MB-N4 notification (N4 Session ID) to the MB-SMF node (500) for activating the MBS session.

The AF (not shown in FIG. 7) sends the MBS activation request (TMGI) to the MB-SMF node (500) directly or via the NEF ((not shown in FIG. 7)).

At operation S702, the MB-SMF node (500) sends the session activation notification (TMGI) to one or more SMF nodes (400). Based on the received TMGI, the SMF node (400) finds the list of UEs (100a-100n) that joined the MBS session identified by the TMGI. If the SMF node (400) determines the user plane of the associated PDU session(s) of the UEs (100a-100n) with respect to the TMGI is activated already.

At operation S703, the SMF node (400) sends the MBS session notification request to the AMF node (300), including (the UE ID list, and TMGI). After receiving the MBS session notification request, for each UE (100) in the list, the AMF node (300) determines the CM state of the UE (100). At operation S704, if the UE (100) involved in the MBS session operates in the CM-connected state, the AMF node (300) responds to the list of the UE (100) involved in the MBS Session and the CM-connected state, using the MBS session notification response (UE ID list). Operations S705-S706 will not be executed for that UEs (100a-100n) in the list. At operations S705-S706, after receiving the MBS session notification response, the SMF node (400) determines the related UE (100) operates in the CM-connected state and sends the Namf_Communication_N1N2 message transfer (e.g., N2 SM message (MBS Session identifier, associated QoS profiles) to the NG-RAN node (200) via the AMF node (300) for the UE (100) which is identified in operation S703. The AMF node (300) sends the N2 request message (e.g., N2 SM message (MBS Session identifier, associated QoS profiles) to the NG-RAN node (200).

At operation S707, the NG-RAN node (200) takes the decision on the PTP/PTM delivery. If the shared tunnel has not been established before, the shared tunnel is established at this step. In addition, the NG-RAN node (200) responds to the SMF node (400). The NG-RAN node (200) configures the UE (100) with RRC messages if needed. At operation S708, the MB-SMF node (500) sends the session activation (TMGI) to the AMF node (300). At operations S709-S710, the AMF node (300) sends the NGAP activation message (TMGI) to the NG-RAN node (200). After receiving the NGAP activation message, the NG-RAN node (200) determines the RRC state of the related UE (100), configures the MBS bearer, and sends multicast activation via the dedicated RRC signalling.

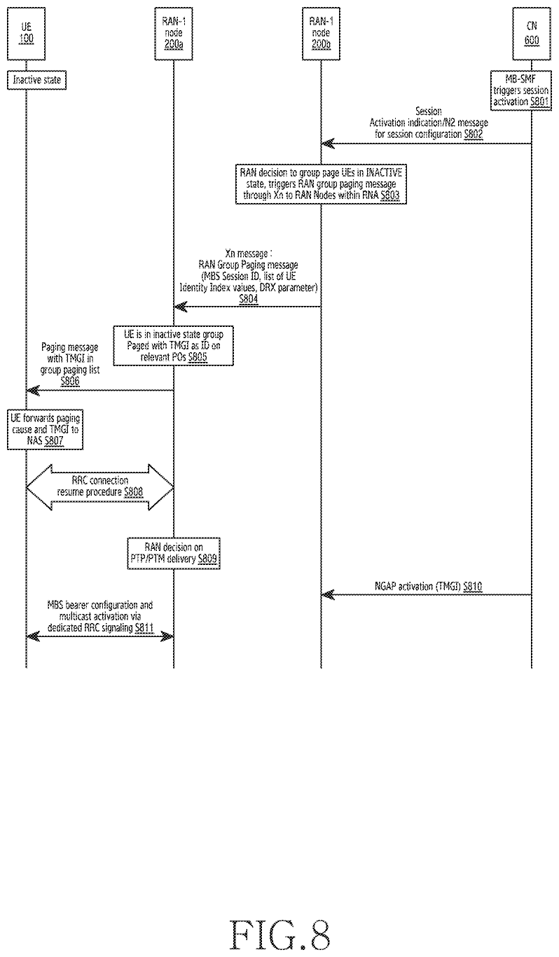

FIG. 8 illustrates a sequence diagram for sending the multicast session activation notification for the UEs (100a-100n) in the RRC inactive state using the group paging on the relevant paging occasions for the UEs (100a-100n) with the non-activated multicast session(s) using an Xn message, according to an embodiment of the disclosure. The sequence diagram includes various network entities such as the UE (100), a RAN-1 node (200a) (e.g., a first NG-RAN node), a RAN-2 node (200b) (e.g., a second NG-RAN node), and a Core Network (CN) (600).

At operation S801, the CN (600) triggers session (e.g., MBS session) activation, where the session activation may be triggered by the following events,

When the MB-UPF (not shown in FIG. 8) receives downlink data for the MBS session, the MB-UPF sends the MB-N4 notification (N4 Session ID) to the MB-SMF node (500) for activating the MBS session.

The AF (not shown in FIG. 8) sends the MBS activation request (TMGI) to the MB-SMF node (500) directly or via the NEF ((not shown in FIG. 8)).

At operation S802, the CN (600) sends a session activation indication/N2 message for session configuration to the RAN-2 node (200b). At operation S803, the RAN-2 node (200b) takes the decision to group page UEs operates in the inactive state, and triggers the RAN group paging message through the Xn message to the RAN-1 node (200a) within RAN based Notification Area (RNA, which is a tracking area comprising of RNA cell list and is used to track the movement of UE in RRC_INACTIVE state). At operation S804, the RAN-2 node (200b) sends the Xn message (i.e. RAN multicast group paging message (MBS Session ID, list of UE Identity Index values, DRX parameter including at least one of UE specific DRX parameter or common DRX parameter).

At operation S805-S806, after receiving the Xn message, the RAN-1 node (200a) initiates the paging procedure for sending CN paging for the UEs (100a-100n) in the list, where the RAN-1 node (200a) sends the CN paging through group paging message with the paging identifier set to TMGI of the session to be activated in the relevant Paging occasions for the UEs (100a-100n) with non-activated sessions alone.

At operations S807-S808, the UE (100) forwards the paging cause and the TMGI to the NAS and established the RRC connection with the NG-RAN node (200). At operation S809, the RAN-1 node (200a) takes the decision on the PTP/PTM delivery. If the shared tunnel has not been established before, the shared tunnel is established at this step. In addition, the RAN-1 node (200a) responds to the CN (600). The RAN-1 node (200a) configures the UE (100) with RRC messages if needed. At operations S810-S811, the CN (600) sends the NGAP activation message (TMGI) to the RAN-2 node (200b). After receiving the NGAP activation message, the RAN-1 node (200a) determines the RRC state of the related UE (100), configures the MBS bearer, and sends the multicast activation via the dedicated RRC signalling.

The following Table-3 shows an example of the RAN multicast group paging message format that was transmitted by the RAN-1 node (200a) to the RAN-2 node (200b).

TABLE 3

| IE/Group | | | IE type and | Semantics | | Assigned |
|---|---|---|---|---|---|---|
| Name | Presence | Range | reference | description | Criticality | Criticality |
| Message | M | | 9.2.3.1 | | YES | reject |
| Type | | | | | | |
| MBS | M | | 9.2.3.146 | | YES | reject |
| Session ID | | | | | | |
| UE | | 1 | | | YES | reject |
| Identity | | | | | | |
| Index List | | | | | | |
| >UE | | 1 . . . | | | | |
| Identity | | <maxnoofUEIDOindicesforMBSPaging> | | | — | |
| Index | | | | | | |
| Item | | | | | | |
| >>CHOI | M | | | | — | |
| CE UE | | | | | | |
| Identity | | | | | | |
| Index | | | | | | |
| Value | | | | | | |
| >>>Length- | | | | | | |
| 10 | | | | | | |
| >>>>Index | M | | BIT STRING | Coded as | — | |
| Length-10 | | | (SIZE(10)) | specified in | | |
| | | | | TS 38.304 | | |
| | | | | [33]. | | |
| >>Paging | O | | UE Specific | Includes the | — | |
| DRX | | | DRX | UE specific | | |
| | | | 9.2.3.143 | paging cycle | | |
| | | | | as defined | | |
| | | | | inTS | | |
| | | | | 38.304 [33]. | | |
| Multicast | M | | RAN Paging | | YES | ignore |
| RAN | | | Area | | | |
| Paging | | | 9.2.3.38 | | | |
| Area | | | | | | |

Additionally, in an embodiment, when the gNB receives session specific multicast session activation request message (i.e. RAN multicast group paging message) from the AMF node (300), the gNB determines the list of UEs (100a-100n) that are in inactive mode. The gNB can send the RAN group paging message including the list of UE identities (i.e. UE identity index values) for the RAN paging to the neighbouring gNBs in the same RNA. The UE identity for the RAN paging is LIE Identity Index value. The MBS session ID is also included in the RAN paging message.

FIG. 9 illustrates a sequence diagram for sending the multicast session activation notification for the UEs (100a-100n) in the RRC inactive state using the group paging on the relevant paging occasions for the UEs (100a-100n) with the non-activated multicast session(s) using an F1 interface, according to an embodiment of the disclosure. The sequence diagram includes various network entities such as the UE (100), the gNB-DU node (200c), the gNB-CU node (200d), and the CN (600).

At operation S901, the CN (600) triggers session (e.g., MBS session) activation, where the session activation may be triggered by the following events,

When the MB-UPF (not shown in FIG. 9) receives downlink data for the MBS session, the MB-UPF sends the MB-N4 notification (N4 Session ID) to the MB-SMF node (500) for activating the MBS session.

The AF (not shown in FIG. 9) sends the MBS activation request (TMGI) to the MB-SMF node (500) directly or via the NEF ((not shown in FIG. 9)).

At operation S902, the CN (600) sends the session activation indication/N2 message for session configuration to the gNB-CU node (200d). At operation S903, the gNB-CU node (200d) takes the decision to group page UEs operates in the inactive state, triggers the RAN group paging message through the F1 interface to the gNB-DU node (200c). At operation S904, the gNB-CU node (200d) sends an F1 message (i.e. multicast group paging message (MBS Session ID, list of UE Identity Index values, DRX parameter including one or more the UE specific DRX parameter and the common DRX parameter).

At operations S905-S906, after receiving the F1 message, the gNB-DU node (200c) initiates the paging procedure for sending CN paging for the UEs (100a-100n) in the list, where the gNB-DU node (200c) sends the CN paging through group paging message with the paging identifier set to TMGI of the session to be activated in the relevant POs for the UEs (100a-100n) with non-activated sessions alone.

At operations S907-S908, the UE (100) forwards the paging cause and the TMGI to the NAS and established the RRC connection with the gNB-DU node (200c). At operation S909, the gNB-CU node (200d) decides on the PTP/PTM delivery. If the shared tunnel has not been established before, the shared tunnel is established at this step. In addition, the gNB-DU node (200c) responds to the CN (600). The gNB-DU node (200c) configures the UE (100) with RRC messages if needed. At operations S910-S911, the CN (600) sends the NGAP activation message (TMGI) to the gNB-CU node (200d). After receiving the NGAP activation message, the gNB-DU node (200c) determines the RRC state of the related UE (100), configures the MBS bearer, and sends multicast activation via the dedicated RRC signalling.

The following Table-4 shows an example of the multicast group paging message format that was transmitted by the gNB-CU node (200d) to the gNB-DU node (200c).

TABLE 4

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.3.1.1 | | YES | ignore |
| MBS Session ID | M | | 9.3.1.218 | | YES | reject |
| UE Identity List | | 0 . . . 1 | | | YES | ignore |
| for Paging | | | | | | |
| >UE Identity | | 1 . . . | | | — | |
| for Paging Item | | <maxnoofUEIDforPaging> | | | | |
| >>UE Identity | M | | 9.3.1.39 | | — | |
| Index value | | | | | | |
| >>Paging | O | | 9.3.1.40 | | — | |
| DRX | | | | | | |
| Paging Cell List | | 0 . . . 1 | | | YES | ignore |
| >Paging Cell | | 1 . . . | | | EACH | ignore |
| Item IEs | | <maxnoofPagingCells> | | | | |
| >>NR CGI | M | | 9.3.1.12 | | — | |

In an embodiment, in the F1 interface, the group paging message (i.e. multicast group paging message) can be initiated by the CU-CP upon receiving an NG-group paging message or upon receiving the RAN-triggered group paging message from another gNB. In the Ng interface, that the UE identity index value is used as UE identity for paging, the group paging procedure in F1 can be unified for both cases. I.e. the UE identity index value can be used as UE identity for the RRC inactive state of the UE (100) and the RRC idle state of the UE (100). The same F1 group paging message is applied to both cases.

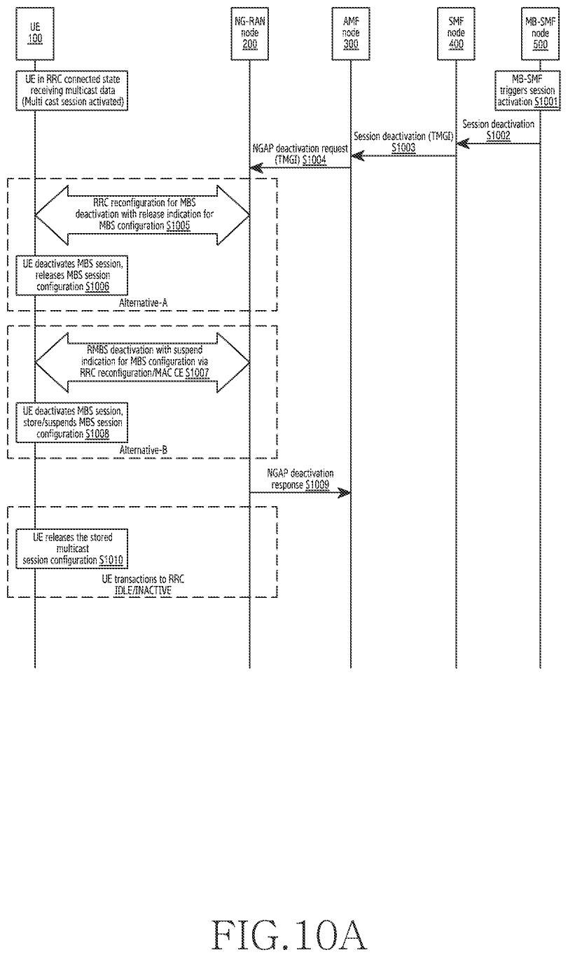

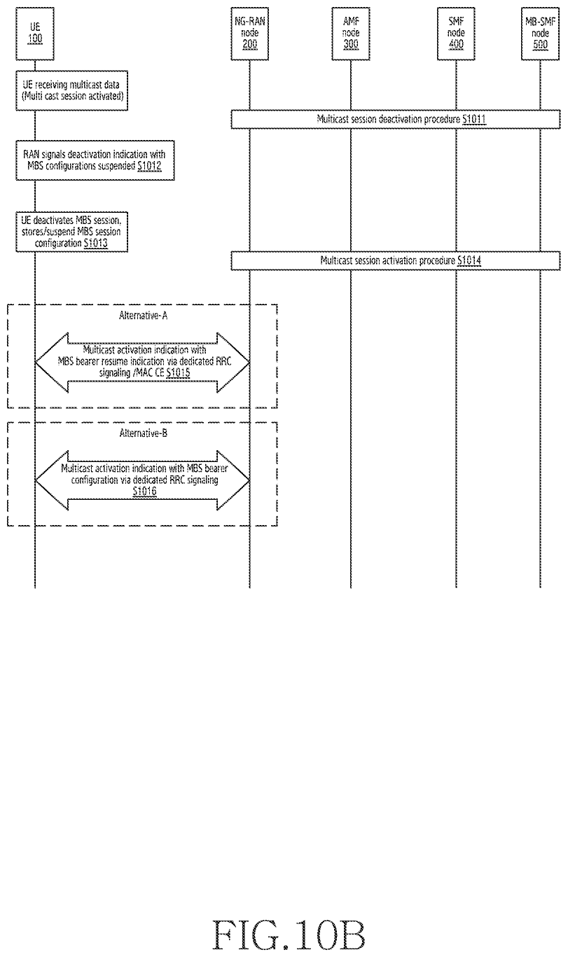

FIGS. 10A and 10B illustrate sequence diagrams where the UEs (100a-100n) operates in the RRC connected state which receives an RRC reconfiguration message for relevant multicast session configuration and/or activation and/or deactivation, according to various embodiments of the disclosure.

Referring to FIG. 10A: consider a scenario where the UE (100) operates in the RRC connected state and receives multicast data (Multicast session activated) from the NG-RAN node (200). At operation S1001, the MB-SMF node (500) triggers session (e.g., MBS session) deactivation, where the session deactivation may be triggered by the following events,

When the MB-UPF (not shown in FIG. 10A) does not receive downlink data for the MBS session, the MB-UPF sends the MB-N4 notification (N4 Session ID) to the MB-SMF node (500) for deactivating the MBS session.

The AF (not shown in FIG. 10A) sends the MBS deactivation request (TMGI) to the MB-SMF node (500) directly or via the NEF ((not shown in FIG. 10A)).

At operation S1002, the MB-SMF node (500) sends a session deactivation (TMGI) to one or more SMF nodes (400). Based on the received TMGI, the SMF node (400) finds the list of UEs (100a-100n) that joined the MBS session identified by the TMGI. If the SMF node (400) determines the user plane of the associated PDU session(s) of the UEs (100a-100n) with respect to the TMGI is activated already. At operation S1003, the SMF node (400) sends the session deactivation (TMGI) to the AMF node (300). At operation S1004, the AMF node (300) sends the NGAP deactivation request (TMGI) to the NG-RAN node (200) upon receiving the session deactivation (TMGI), where the NG-RAN node (200) performs one or more actions (e.g., alternative-A or alternative-B).

At operation S1005, the NG-RAN node (200) performs the RRC reconfiguration for an MBS deactivation with a release indication for the MBS configuration. At operation S1006, the UE (100) deactivates the MBS session and releases the MBS configuration. At operation S1007, the NG-RAN node (200) performs the MBS deactivation with suspending indication for the MBS configuration via the RRC reconfiguration/MAC CE. At operation S1008, the UE (100) deactivates the MBS session, and stores/suspends the MBS session configuration. At operation S1009, the NG-RAN node (200) sends the NGAP deactivation response to the AMF node (300). At operation S1010, the UE (100) releases the stored multicast session configuration, and the UE (100) transits to the RRC idle state or the RRC inactive state from the RRC connected state.

Referring to FIG. 10B: consider a scenario where the UE (100) operates in the RRC connected state and receives multicast data (Multicast session activated) from the NG-RAN node (200). At operation S1011, the multicast session deactivation procedure is initiated by the network entity (e.g., NG-RAN node (200), AMF node (300), SMF node (400), and MB-SMF node (500)). At operation S1012, the NG-RAN node (200) signals deactivation indication with MBS configurations suspended to the UE (100). At operation S1013, the UE (100) deactivates the MBS session and stores/suspends the MBS session configuration.

At operation S1014, the multicast session activation procedure is initiated by the network entity (e.g., NG-RAN node (200), AMF node (300), SMF node (400), and MB-SMF node (500)), where the NG-RAN node (200) performs one or more action (e.g., alternative-A or alternative-B). At operation S1015, the NG-RAN node (200) sends the multicast activation indication with an MBS bearer resume indication via the dedicated RRC signalling/MAC-CE. At operation S1016, the NG-RAN node (200) sends the multicast activation indication with an MBS bearer configuration via the dedicated RRC signalling.

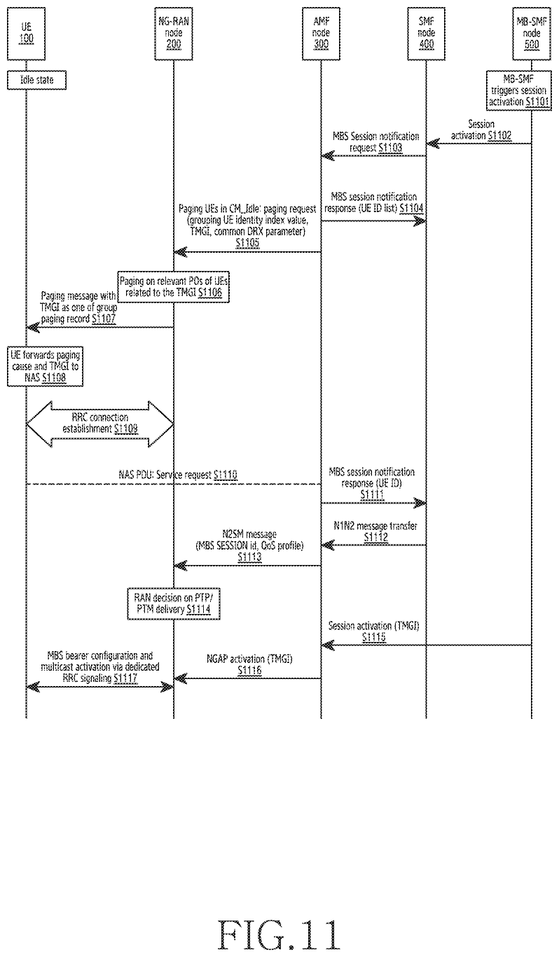

FIG. 11 illustrates a sequence diagram for sending the multicast session activation notification for the UEs (100a-100n) in the RRC idle state using the group paging on relevant paging occasions for the UEs (100a-100n) related to the TMGI, according to an embodiment of the disclosure.

At operation S1101, the MB-SMF node (500) triggers session (e.g., MBS session) activation, where the session activation may be triggered by the following events,

When the MB-UPF (not shown in FIG. 11) receives the downlink data for the MBS session, the MB-UPF sends the MB-N4 notification (N4 Session ID) to the MB-SMF node (500) for activating the MBS session.

The AF (not shown in FIG. 11) sends the MBS activation request (TMGI) to the MB-SMF node (500) directly or via the NEF ((not shown in FIG. 11)).

At operation S1102, the MB-SMF node (500) sends the session activation notification to one or more SMF nodes (400). Based on the received TMGI, the SMF node (400) finds the list of UEs (100a-100n) that joined the MBS session identified by the TMGI. If the SMF node (400) determines the user plane of an associated PDU session(s) of the UEs (100a-100n) with respect to the TMGI are activated already, operations S1103-S1109 will be skipped for the UE (100).

At operation S1103, the SMF node (400) sends the MBS session notification request to the AMF node (300). After receiving the MBS session notification request, for each UE (100) in the list, the AMF node (300) determines the CM state of the UE (100). At operation S1104, if the UE (100) involved in the MBS session operates in the CM-connected state, the AMF node (300) responds to the list of the UE (100) involved in the MBS Session and the CM-connected state, using the MBS session notification response (UE ID list). Operations S1105-S1106 will not be executed for that UEs (100a-100n) in the list.

At operation S1105, if the AMF node (300) determines that there are any UEs (100a-100n) in the CM-IDLE state (i.e. RRC_IDLE) and involved in the MBS Session, and the AMF node (300) figures out the paging area considering all the UEs (100), which need to be paged. The AMF node (300) sends the paging request message (UE Identity index value, TMGI, common DRX parameter) (i.e. multicast group paging message) to the NG-RAN node(s) (e.g., one or more RAN (200)) belonging to the paging area with the TMGI as the identifier to be paged if the related NG-RAN node (200) support the MBS session. At operations S1106-S1107, after receiving the paging request, the NG-RAN node (200) initiates the paging procedure for sending CN paging for the UEs (100a-100n) in the list, where the NG-RAN node (200) sends the CN paging through group paging message with the paging identifier set to TMGI of the session to be activated in the relevant POs for the UEs (100a-100n) related to the TMGI with non-activated sessions alone.

At operations S1108-S1109, the UE (100) forwards the paging cause and the TMGI to the NAS and established the RRC connection with the NG-RAN node (200). At operation S1110, the UE (100) operates in the IDLE state and sends the service request to the AMF node (300). At operation S1111, after receiving the service request sent by the UE (100), the AMF node (300) responds to the SMF node (400) with the MBS session notification response (UE ID). At operations S1112-S1113, after receiving the MBS session notification response, the SMF node (400) determines the related UE (100) operates in the CM-connected state and sends the Namf_Communication_N1N2 message transfer (e.g., N2 SM message (MBS Session identifier, associated QoS profiles) to the NG-RAN node (200) via the AMF node (300) for the UE (100) which is identified in operation S503. The AMF node (300) sends the N2 request message (e.g., N2 SM message (MBS Session identifier, associated QoS profiles) to the NG-RAN node (200).

At operation S1114, after receiving the N2 message, the NG-RAN node (200) takes the decision on PTP/PTM delivery. If the shared tunnel has not been established before, the shared tunnel is established at this step. In addition, NG-RAN node (200) responses to the SMF node (400). The NG-RAN node (200) configures the UE (100) with the RRC messages if needed.

At operation S1115, the MB-SMF node (500) sends the session activation (TMGI) to the AMF node (300). At operations S1116-S1117, the AMF node (300) sends the NGAP activation message (TMGI) to the NG-RAN node (200). After receiving the NGAP activation message, the NG-RAN node (200) determines the RRC state of the related UE (100), configures the MBS bearer, and sends the multicast activation via the dedicated RRC signalling.

In another embodiment, the group paging message (e.g. multicast group paging message) carries a common paging DRX information (e.g. paging DRX cycle length) for all the UEs (100) which need to be provided group notification. This common paging DRX information can be the CN paging cycle length instead of UE-specific paging cycle length. As UE-specific paging cycle lengths are per UE and can be different for different UEs (100a-100n), there is a significant saving message size with a common CN paging DRX cycle length. In an alternative, this common DRX cycle length can be any fixed value other than CN paging DRX cycle length. As shown in FIG. 11, the AMF node (300) can signal the group paging request message to the NG-RAN (200) by grouping the UE identity index value along with a common DRX configuration which could either be a fixed value or a common CN paging cycle configuration.

In another embodiment, if the multicast session pertains to a low latency service, all relevant UEs (100a-100n) receiving multicast sessions may have UE-specific DRX cycle length. In this case, a common DRX cycle length can be used which may be the same as the UE-specific DRX cycle length.

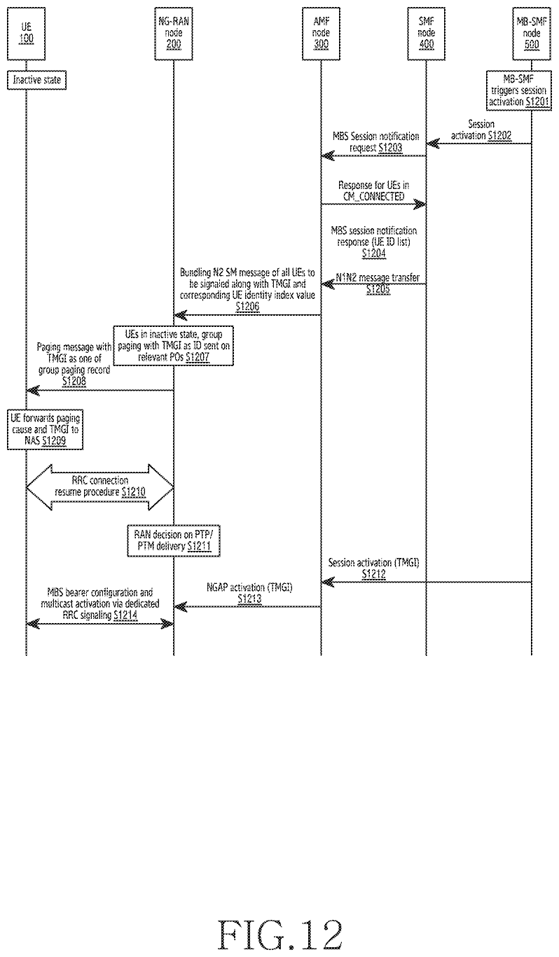

FIG. 12 illustrates a sequence diagram for sending the multicast session activation notification for the UE(s) (100a-100n) in the RRC inactive state by bundling an N2 SM message of all UEs (100) to be signaled along with TMGI and corresponding UE identity index value, according to an embodiment of the disclosure.

At operation S1201, the MB-SMF node (500) triggers session (e.g., MBS session) activation, where the session activation may be triggered by the following events,

When the MB-UPF (not shown in FIG. 12) receives downlink data for the MBS session, the MB-UPF sends the MB-N4 notification (N4 Session ID) to the MB-SMF node (500) for activating the MBS session.

The AF (not shown in FIG. 12) sends the MBS activation request (TMGI) to the MB-SMF node (500) directly or via the NEF ((not shown in FIG. 12)).

At operation S1202, the MB-SMF (35) sends the session activation notification (TMGI) to one or more SMF nodes (400). Based on the received TMGI, the SMF node (400) finds the list of UEs (100a-100n) that joined the MBS session identified by the TMGI. If the SMF node (400) determines the user plane of the associated PDU session(s) of the UEs (100a-100n) with respect to the TMGI are activated already, operations S618-S624 will be skipped for the UE (100).

At operation S1203, the SMF node (400) sends the MBS session notification request to the AMF node (300), including (the UE ID list, and TMGI). After receiving the MBS session notification request, for each UE (100) in the list, the AMF (300) determines the CM state of the UE (100), as given in operations S619-S621. At operation S1204, if the UE (100) involved in the MBS session operates in the CM-connected state, the AMF node (300) responds to the list of the UE (100) involved in the MBS Session and the CM-connected state, using the MBS session notification response (UE ID list). Operations S620-S621 will not be executed for that UEs (100a-100n) in the list. At operation S1205, after receiving the MBS session notification response, the SMF node (400) determines the related UE (100) operates in the CM-connected state and sends the Namf_Communication_N1N2 message transfer (e.g., N2 SM message (MBS Session identifier, associated QoS profiles) to the NG-RAN node (200) via the AMF node (300) for the UE (100) which is identified in operation S603. The AMF node (300) sends an N1N2 request message transfer to the NG-RAN node (200).

At operation S1206, if the AMF node (300) determines that there are any UEs (100a-100n) in the CM-IDLE state (i.e. RRC_IDLE) and involved in the MBS Session, and the AMF node (300) figures out the paging area considering all the UEs (100), which need to be paged. The AMF node (300) sends the bundling of the N2 SM message of all UEs (100) to be signaled along with TMGI and corresponding UE identity index value (i.e. multicast group paging message) to the NG-RAN node(s) (e.g., one or more RAN (200)) belonging to the paging area with the TMGI as the identifier to be paged if the related NG-RAN node (200) support the MBS session.

At operations S1207-S1208, after receiving the bundling of the N2 SM message, the NG-RAN node (200) initiates the paging procedure for sending CN paging for the UEs (100a-100n) in the list, where the NG-RAN node (200) sends the CN paging through group paging message with the paging identifier set to TMGI of the session to be activated in the relevant POs for the UEs (100a-100n) with non-activated sessions alone.

At operations S1209-S1210, the UE (100) forwards the paging cause and the TMGI to the NAS and established the RRC connection with the NG-RAN node (200). At operation S1211, the NG-RAN node (200) takes the decision on the PTP/PTM delivery. If the shared tunnel has not been established before, the shared tunnel is established at this step. In addition, the NG-RAN node (200) responds to the SMF node (400). The NG-RAN node (200) configures the UE (100) with RRC messages if needed. At operation S1212, the MB-SMF node (500) sends the session activation (TMGI) to the AMF node (300). At operations S1213-S1214, the AMF node (300) sends the NGAP activation message (TMGI) to the NG-RAN node (200). After receiving the NGAP activation message, the NG-RAN node (200) determines the RRC state of the related UE (100), configures the MBS bearer, and sends multicast activation via the dedicated RRC signalling.

In another embodiment, as shown in FIG. 12, the AMF bundles the N2 messages for the PMM connected UE and sends this message to the gNB along with the TMGI value. The gNB performs the RAN group paging to the UEs (100a-100n) in the RRC inactive state using the TMGI as the paging identity. The gNB sends the RAN group paging message to other gNBs in the same RNA in a newly defined Xn-based RAN group paging message. In another embodiment, the UE identity index value is provided pertaining to the relevant POs for the inactive UEs which have a non-activated multicast session, and/or common DRX information is provided for the group notification of inactive UEs.

Another opportunity to trigger the RAN group paging for the inactive mode UE is after operation 1212 in FIG. 12. When the gNB receives session specific Activation Request message from the AMF node (300), the gNB determines the list of UEs (100a-100n) are in inactive mode and the gNB can send the RAN group paging message including the list of UE identity for RAN paging to the neighbouring gNBs in the same RNA. The UE identity for RAN paging is the UE identity index value. The MBS session ID is also included in the RAN paging message. The RAN group paging message can contain a common DRX IE to cover all UE-specific DRX cycles.

The various actions, acts, blocks, steps, or the like in the sequence diagrams (FIGS. 3A, 3B, 4A to 4D, 5A to 5C, 6A, 6B, 7 to 9, 10A, 10B, 11 and 12) may be performed in the order presented, in a different order, or simultaneously. Further, in some embodiments, some of the actions, acts, blocks, steps, or the like may be omitted, added, modified, skipped, or the like without departing from the scope of the disclosure.

In an embodiment, the CN (600) paging is used for paging for both the RRC idle state and the RRC inactive state of the UEs (100a-100n) for the multicast session activation notification.

Modification to paging message structure to include MBS session ID for group paging: In an embodiment, a new IE/Field is introduced to the Paging message to signal the list of MBS sessions that are being activated. In an example implementation, the new field GrpPagingRecordList-r17, is introduced by extending the paging message using the non-critical Extensions.

The new field holds a list of GrpPagingRecord each consisting of MBS session IDs in the form TMGI and/or a notification reason/cause. The reason can be at least one of the following—activation, deactivation, configuration, modification, release, de-configuration.

Paging message is as below—

| -- ASN1START | |
|---|---|
| -- TAG-PAGING-START | |
| Paging ::= | SEQUENCE { |
| pagingRecordListPagingRecordList | |
| OPTIONAL, -- Need N | |
| lateNonCriticalExtension | OCTET STRINGOPTIONAL, |
| nonCriticalExtension | GrpPagingRecordList- |
| r17OPTIONAL | |
| } | |
| grpPagingRecordList-r17 ::= | SEQUENCE |
| { | |
| grpPagingRecordList-r17 | SEQUENCE |
| (SIZE(1..maxNrofGrpPageRec)) OF GrpPagingRecord, | |
| nonCriticalExtension | SEQUENCE{ } |
| OPTIONAL | |
| } | |
| GrpPagingRecord ::= | |
| SEQUENCE { | |
| mbsSessionId-r17 | 5G-TMGI-r17, |
| notificationType | ENUMERATED |
| {activation,deactivation,modification,release...}, | |
| ... | |
| } | |
| 5G-TMGI-r17 ::= | |
| SEQUENCE { | |
| plmn-Id | |
| CHOICE { | |
| index | |
| INTEGER (1...maxPLMNIdentities), | |
| explicitValue | |
| PLMN-Identity | |
| }, | |
| ServiceId-r17 | OCTET |
| STRING (SIZE (3)) | |
| } | |
| -- TAG-PAGING-STOP | |
| -- ASN1STOP | |

_GrpPagingRecord Field Descriptions:

mbsSessionId-r17: Indicates the TMGI associated with the MBS session which is being activated. If a UE has been registered/configured to receive this MBS session and is still interested in the session, UE moves from RRC_IDLE/RRC_INACTIVE state to RRC_CONNECTED state to receive the multicast data.

notificationType: Indicates a reason for the notification, if the notification is for activation, deactivation, modification or release of the associated MBS session. The UE performs the intended actions based on the notification type.

Procedure for the UE (100) upon receiving the paging message (one or more multicast services)—Upon receiving the paging message, the UE (100) shall:

1> if in RRC_IDLE, for each of the PagingRecord, if any, included in the Paging message:
2> if the ue-Identity included in the PagingRecord matches the UE identity allocated by upper layers:
   3> forward the ue-Identity and accessType (if present) to the upper layers;

1> if in RRC_IDLE, for each of the GrpPagingRecord, if any, included in the Paging message:
2> if the mbsSessionId-r17 included in the GrpPagingRecord matches the TMGI value associated with a multicast session configured but session is non-activated at present,
   3> forward the TMGI and/or notificationType to the upper layer

1> if in RRC_INACTIVE, for each of the PagingRecord, if any, included in the Paging message:
2> if the UE-Identity included in the PagingRecord matches the UE's stored fullI-RNTI:
   3> if the UE is configured by upper layers with Access Identity 1:
      4> initiate the RRC connection resumption procedure according to 5.3.13 with resumeCause set to mps-PriorityAccess;

3> else if the UE is configured by upper layers with Access Identity 2:
4> initiate the RRC connection resumption procedure according to 5.3.13 with resumeCause set to mcs-PriorityAccess;

3> else if the UE (100) is configured by upper layers with one or more Access Identities equal to 11-15:
4> initiate the RRC connection resumption procedure according to 5.3.13 with resumeCause set to highPriorityAccess;

3> else:
4> initiate the RRC connection resumption procedure according to 5.3.13 with resumeCause set to mt-Access;

2> else if the UE-Identity included in the PagingRecord matches the UE identity allocated by upper layers:
3> forward the UE-Identity to upper layers and accessType (if present) to the upper layers;
3> perform the actions upon going to RRC_IDLE as specified in 5.3.11 with release cause ‘other’.

1> if in RRC_INACTIVE, for each of the GrpPagingRecord, if any, included in the Paging message:
2> if the mbsSessionId-r17 included in the GrpPagingRecord matches the TMGI value associated with a multicast session configured but inactive in the UE (100),
   3> the UE (100) performs one or a combination of the following steps

forward the TMGI and notificationType to the upper layer

based on the notificationType, initiate the RRC connection resumption procedure with resumeCause set in accordance with the type of MBS access (e.g. delay tolerant or delay critical and/or lowPriorityMBS/highPriorityMBS/criticalMBS)

In an embodiment, the UE (100) in the RRC inactive state monitors for the CN paging and also decodes for the non-activated multicast session activation notification and if present, processes the paging message (i.e. multicast group paging message, a RAN multicast group paging message, etc.). Further, the UE (100) resumes the RRC connection and comes to the RRC connected state to join/re-join the MBS multicast session which is notified as activated. Since the CN paging may be present if there is at least another UE (100a) in the RRC idle state in the cell for which the MBS multicast session is being activated and/or there is a state mismatch between the UE (100) and the CN (600) and/or the UE (100) is not reachable to the CN (600), it is possible the RRC inactive state may not be able to always receive the CN paging for the multicast session activation notification.

In an embodiment, the UE (100) in the RRC inactive state is paged using the RAN paging (i.e. RAN multicast group paging message) by the NG-RAN node (200) (e.g. gNB) when one or more relevant MBS multicast session is activated. The RRC inactive UE monitors the RAN paging as per the paging configuration and decodes the TMGIs for the relevant multicast session(s), if present, and processes the same.

In an embodiment, the UE (100) is configured by the NG-RAN node (200) (e.g. gNB), when the UE (100) operates in the RRC connected state as follows:

If the UE (100) which joined the multicast session operates in the RRC connected state, the gNB sends the RRC Reconfiguration message with relevant MBS configuration for the multicast session to the UE (100) and there is no need for separate session activation notification for the UE (100).

If the multicast session is deactivated when the UE (100) operates in the RRC connected state, the gNB sends the RRC reconfiguration message indicating deactivating and/or the release of relevant MBS configuration for the multicast session to the UE (100).

In another embodiment, the gNB sends the RRC reconfiguration message indicating deactivation and/or a suspension of relevant MBS configuration for the multicast session. Therefore, the UE (100) stores the relevant MBS configuration for the deactivated multicast session as long as it remains in the RRC connected state. In the case, the UE (100) transits out of the RRC connected state (e.g. RRC idle state, RRC inactive state), and/or data inactivity timer expires, the UE (100) releases the relevant MBS configuration for the deactivated multicast session.

In another embodiment, the gNB sends a MAC Control element (CE) to indicate the deactivation and/or suspension of the relevant MBS configuration of the multicast session.

If the multicast session is activated, which was previously deactivated, when the UE (100) operates in the RRC connected state, the gNB sends the RRC reconfiguration message indicating the activation and/or with the relevant MBS configuration for the multicast session to the UE (100).

In another embodiment, the gNB sends the RRC reconfiguration message indicating the activation and/or resume of the relevant MBS configuration for the multicast session. Therefore, the UE (100) restores the relevant MBS configuration for the deactivated multicast session as long as it remains in the RRC connected state.

In another embodiment, the gNB sends the MAC-CE to indicate the activation and/or resume of relevant the MBS configuration of the multicast session.

In an embodiment, the UE (100) maintains the MBS configuration or MRB (MBS radio bearer) for a deactivated session even while it operates in the RRC connected state and/or is transitioned to the RRC inactive state.

In another embodiment, the MRB for one or more joined, activated, and deactivated multicast sessions is suspended when there is RRC release with suspend configuration received. Further, the suspended MRB is resumed upon reception of an RRC resume message in response to an RRC resume request/1 message from the UE (100). The RRC resume request/1 can be triggered in response to the RAN paging caused by legacy unicast paging or group notification.

In an embodiment, transmission and/or reception of an MRB multicast is suspended when one or more conditions for a Master Cell Group (MCG) and detection of a Radio Link Failure (RLC) are met.

To summarize,

Session join—NAS signalling is utilized by the UE (100)/CN to join the session

session activation—RAN utilizes RRC signalling e.g. RRC reconfiguration with MBS configuration

Session deactivation—RAN utilizes RRC signalling e.g. RRC reconfiguration (including one or more of only deactivation indication and/or release of MBS configuration and/or suspension of MBS configuration for the multicast session)

Session activation—RAN utilizes RRC signalling e.g. RRC reconfiguration (including one or more of only activation indication and/or resume of MBS configuration and/or providing MBS configuration for the multicast session)

Further, the multicast session in the RRC reconfiguration message is indicated with related TMGI. An RRC layer will indicate or notify the upper layer or NAS layer about the activation and/or deactivation status of the multicast session. Accordingly, the RRC layer also configures or de-configures the lower layers (e.g. PDCP, RLC, MAC, and PHY) for the multicast session.

In another embodiment, there can be a solution provided for the potential conflict of resume caused when the RRC inactive UE receives both legacy unicast paging and group notification for multicast session activation. In the example below for illustration purposes, for group notification, mt-access cause is considered, but it is not limited to this value.

The following is a sample specification text proposed to 3GPP TS 38.331 to handle UE reception of a paging message.

1> if in RRC_INACTIVE, for each of the PagingRecord, if any, included in the Paging message:

2> if the ue-Identity included in the PagingRecord matches the UE's stored fullI-RNTI:

3> if the UE is configured by upper layers with Access Identity 1:

4> initiate the RRC connection resumption procedure according to 5.3.13 with resumeCause set to mps-PriorityAccess;

3> else if the UE is configured by upper layers with Access Identity 2:

4> initiate the RRC connection resumption procedure according to 5.3.13 with resumeCause set to mcs-PriorityAccess;

3> else if the UE is configured by upper layers with one or more Access Identities equal to 11-15:

4> initiate the RRC connection resumption procedure according to 5.3.13 with resumeCause set to highPriorityAccess;

3> else:

4> initiate the RRC connection resumption procedure according to 5.3.13 with resumeCause set to mt-Access;

2> else if the ue-Identity included in the PagingRecord matches the UE identity allocated by upper layers:

3> forward the ue-Identity to upper layers and accessType (if present) to the upper layers;

3> perform the actions upon going to RRC_IDLE as specified in 5.3.11 with release cause ‘other’.

1> for each TMGI included in pagingGroupList, if any, included in the Paging message:

2> if the UE has joined an MBS session indicated by the TMGI included in the pagingGroupList:

3> forward the TMGI to the upper layers;

1> if in RRC_INACTIVE and the UE has joined one or more MBS session(s) indicated by the TMGI included in the pagingGroupList:

initiate the RRC connection resumption procedure according to 5.3.13 with resumeCause set to mt-Access if not already set to higher priority cause.

In an embodiment, the UE (100) and/or the NG-RAN node (200) considers the activation and/or deactivation of the multicast session to consider for Bandwidth Part (BWP) switching/maintenance and/or supporting running/stopping unicast services along with multicast session given the capability limitations for the UE (100) is now applicable or is now removed with activation and/or deactivation.

In an embodiment, the NG-RAN node (200) (e.g. gNB) stores the MBS context and/or relevant MBS configuration for the multicast session for the UE (100) when the UE (100) operates in one or more RRC connected states and/or the RRC inactive state. The NG-RAN node (200) can therefore provide the MBS configuration to the UE (100) when the multicast session is activated.

In an embodiment, the NG-RAN node (200) (e.g. gNB) stores the MBS context and/or relevant MBS configuration for the multicast session when there is one or more UE (100a-100n) in the cell or coverage with the multicast session. The NG-RAN node (200) can therefore provide the MBS configuration to another UE (100a) when the multicast session is activated.

In an embodiment, when the UE (100) operates in a non-MBS cell, the pertinent NG-RAN node (200) will utilize the legacy paging approach to indicate the UE (100) to transit to the RRC connected state and configure/avail multicast service through dedicated signalling (e.g. session join/re-join).

Group Paging Issues for the UEs (100a-100n) in the idle state: the POs are time-slots when the UE (100) listens to paging broadcasts. In this case, the UEs (100a-100n) and network (e.g., NG-RAN node (200)) negotiate paging occasions according to the radio network capabilities of the UE (100), the UE Identity, and a network configuration. The UEs (100a-100n) radio capabilities for paging are stored by the gNB into the AMF node (300) when the UE (100) moves to the idle state. Later, when the AMF node (300) needs to page the UE (100), it provides the gNB with UE-Identity and the UE radio capabilities for paging, to help the NG-RAN node (200) to determine the paging strategy.

In the case of multicast, the network entity (e.g. NG-RAN (200)) needs to page all the UEs (100) who had earlier joined the multicast session. Since all these UEs (100a-100n) may have negotiated different POs with the network, There are following issues:

If the AMF node (300) requests the gNB to initiate paging using the TMGI, not all the UEs (100) who want to join the multicast session indicated by the TMGI need to have common POs. Thus, the network entity does not know how to page the UEs (100a-100n), or which PO to page the UEs (100a-100n) on.

Hence, the network entity can do the following:

In an embodiment, paging for multicast session activation notification is used in all legacy POs. This approach, however, results in the wastage of network resources.

In an embodiment, the UE (100) and the NG-RAN node (200) negotiate, apart from legacy POs, an additional paging occasion to which the UE (100) should listen for multicast paging. Such a paging occasion could be, e.g., common to all the UEs (100) of a multicast group. Such a paging occasion could also be specified for each TMGI. This approach, however, results in lower batter life for the UE (100) as it has to listen to unicast and multicast paging occasions separate channels.

In an embodiment, the AMF node (300) performs the unicast paging for all the UEs (100) who joined the multicast session and later went to the idle state. For such UEs (100a-100n), the AMF node (300) could provide the TMGI as an additional parameter (apart from UE-ID and UE Radio Capabilities for Paging) to the NG-RAN node (200). Which helps the UE (100) quickly determine that the paging is for the multicast session.

Alternatively, in an embodiment, while providing group paging requests including the TMGI, the AMF (300) also provides to the gNB the “UE Radio Capability for Paging” and the list of UE_IDs that needs to be paged. Then, based on the information provided, the gNB determines the paging occasions on which group paging including TMGI should be performed.

The UE radio capability paging is an IE whose size may run into several hundreds of bytes. In the scenario where the AMF node (300) provides the gNB with the UE Radio capability for paging for all the UEs (100) who need to join the multicast session, the messaging may become large and performance intensive. The problem becomes magnified since the AMF node (300) may need to do this towards multiple cells in the multicast Service area. In such a scenario, it is proposed to use a RACS framework as defined in 3GPP TS 23.501 Clause 5.4.4.1a, and extend RAC-ID to include the UE radio capability for paging. In an embodiment, it is proposed that the paging message sent by the AMF node (300) to the gNB contains RAC-ID for paging for the corresponding UE (100). In the case of group paging, the request contains a mapping of UE-ID to the corresponding RAC-ID for paging.

In an embodiment, the UE (100) and the AMF node (300) negotiate a specific DRX cycle for multicast services. The AMF node (300) provides the negotiated DRX information with the NG-RAN node (200) when it requests the NG-RAN node (200) to perform paging for multicast service. Such information could be used, e.g. for low latency multicast service. Possible approaches include the UE (100) requesting for the UE-specific DRX e.g. TAU (Tracking Area Update)/RAU/RNAU request message indicating desired UE-specific DRX value and network acknowledging the same.

In another embodiment, the UE (100) utilizes UE Assistance Information (UAI) message to require or indicate preferred paging configuration parameters e.g. paging DRX cycle length.

In an embodiment, the group paging message in the Ng interface is only aimed for PMM-IDLE mode UE. The AMF node (300) doesn't trigger Group Paging for inactive mode UEs. The AMF node (300) sometimes doesn't know the UE (100) operates in inactive mode. If the associated PDU sessions with respect to TMGI are not setup, the MB-SMF sends N2 message to the gNB to setup the associated PDU session. If the UE (100) operates in a Packet Mobility Management (PMM) connected mode, the AMF node (300) forwards the N2 message to the gNB. When the gNB receives the UE specific N2 message and determines the UE (100) operates in RRC Inactive mode, the gNB sends RAN paging message to the UE and to the gNBs in the same RNA. A group paging message in Xn interface can be defined. But it is doubtful if the RAN group paging can be used here, since the gNB receives multiple UE specific N2 messages and gNB doesn't know which one is the last one. It is hard for the gNB to map into one RAN group paging message if the gNB doesn't know how many messages will be received from the CN. Therefore, legacy RAN paging message can be used here when the gNB receives message for the UE in RRC Inactive mode.

Redirecting UEs (100a-100n) to a cell with supporting multicast transmission: A multicast service may be available only in a specific multicast service area. Alternatively, some UEs (100a-100n) may be located in cells where shared transmission is not supported and RAN wants to move such UEs (100a-100n) to a nearby cell(s) which support shared transmission, to optimize resources. In such a case, there is a need to entice the UEs (100a-100n) to reselect to the nearby cell or to use network-aided redirect procedures.

In an embodiment, a frequency which is supporting multicast is prioritized for cell reselection when the UE (100) in the RRC idle state and/or the RRC inactive state is monitored for the multicast session activation notification.

The UE (100) can be in the non-MBS cell, wherein it has to receive legacy paging message to get connected and then avail multicast service through unicast or PTP mode

The UE (100) can be in the MBS cell, wherein it has to receive legacy paging messages including the group paging i.e. multicast session activation notification for the relevant TMGI.

In both cases, the UE (100) can prioritize frequency supporting multicast or multicast session activation notification.

In an embodiment, frequency/frequencies supporting multicast are indicated in a SIB (system information block) message. The SIB can be transmitted in both MBS cells and non-MB S cells. The SIB carries the mapping of multicast session and frequency and/or service area identity/identities. In an alternative, multicast frequencies can be provided in the RRC release message (when the UE (100) transiting to RRC idle state) or RRC Release with suspending config message (when the UE (100) transiting to RRC inactive state) or RRC release with redirection message can redirect or inform the UE (100) for multicast frequencies. The UE (100) may prioritize multicast frequencies for cell reselection when the UE (100) has one or more non-activated multicast sessions for which it needs to monitor group notification.

In an embodiment, the SIB (e.g. SIB1 or MBS SIB or a different/new SIB) carries the indication of whether the present cell supports MBS and/or multicast. Based on this indication, the UE (100) can prefer the cell for the cell selection and/or cell reselection when it is interested to receive the multicast session and/or monitoring for the multicast session activation notification.

In an embodiment, neighbour cell information for the multicast sessions can be provided in the SIB and/or MCCH and/or dedicated RRC signalling messages which are supporting specific multicast services.

In an embodiment, when the UE (100) transits between the MBS node and the non-MBS node, the NG-RAN node (200) and the UE (100) switch from the approach of receiving Paging for activation notification and legacy paging and vice-versa.

In an embodiment, when the paging configuration changes e.g. when the UE (100) performs cell reselection, NAS procedures, mobility updates, network changes paging configuration and/or UE identity due to security reasons, paging reception for multicast session activation notification is accordingly modified by the UE (100) and the NG-RAN node (200)/the CN (600) entities. That is, the NG-RAN node (200) and/or the CN (600) will provide multicast session activation notification as per the new paging configuration for the UE (100). Accordingly, there will be communication between the NG-RAN node (200) and the CN (600) entities to update others about the new configuration as applicable.

In an embodiment, the AMF node (300) sends the NGAP activation message (TMGI) to the RAN node(s) (200). The NG-RAN node (200) based on the RRC state of the UEs (100a-100n), will initiate sending of the relevant message towards the UE (100).

The NG-RAN node (200) page to the RRC inactive UE to indicate multicast session activation notification.

The RRC reconfiguration to the RRC connected UE includes an indication for the multicast session activation and/or configuration for the multicast session which is activated

The NG-RAN node (200) may maintain the context for the multicast session configuration for the RRC inactive state and/or the RRC connected UE(s) and configure the UE (100) when it is in the RRC connected state or comes to the RRC connected state after resuming from the RRC inactive state.

In an embodiment, the paging message is sent over the interface between the CN (600) and the NG-RAN node (200) as one or more of the following:

per-UE as in legacy but additionally TMGI parameter;

per TMGI grouped (may include relevant UE IDs);

per-PO (grouped as per common DRX i.e. PO wise) e.g. UE Identity Index value along with TMGI and/or common DRX information; and

only TMGI—this can work with RAN transmitting paging in all legacy POs;

When the multicast group paging message is sent by the AMF node (300) to the NG-RAN node (200) with multiple options for Group Paging Request. The AMF node (300) can send a message containing, e.g.

TMGI alone

TMGI along with the list of UE Identities to be paged

TMGI along with the list of UE Identities to be paged and the corresponding “UE radio capability for paging” information.

The embodiments disclosed herein can be implemented using at least one hardware device and performing network management functions to control the elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for performing multicast group paging for a Multicast Broadcast Services (MBS) multicast session activation notification in a wireless network, the method comprising:
receiving, by a Next Generation Radio Access Network (NG-RAN) node, a multicast group paging message from an Access and Mobility Management Function (AMF) node;
determining, by the NG-RAN node, one or more User Equipment (UE) that has to be paged for the MBS multicast session activation notification based on the received multicast group paging message;
determining, by the NG-RAN node, one or more Paging Occasion (PO) to send the page for the MBS multicast session activation notification based on the received multicast group paging message; and
performing, by the NG-RAN node, the multicast group paging for one or more determined UE,
wherein the NG-RAN node pages the MBS multicast session activation notification to one or more determined UE based on the determined one or more PO.

2. The method of claim 1, wherein the multicast group paging message comprises at least one of a message type, an MBS session Identity (ID), an MBS service area, a multicast group paging area list, a multicast group paging area item, a multicast group paging area, a UE paging list, a UE paging item, a UE identity index value, a paging Discontinuous Reception (DRX) including at least one of a UE specific DRX parameter and a common DRX parameter.

3. The method of claim 1, wherein one or more UE operates in a Radio Resource Control (RRC) idle state or a RRC inactive state with a non-activated MBS multicast session as indicated by an MBS session identity (ID) in the multicast group paging message.

4. The method of claim 1, wherein the performing, by the NG-RAN node, of the multicast group paging for one or more determined UE based on the determined one or more PO comprises:
sending, by the NG-RAN node, the multicast group paging to one or more determined UE for the MBS multicast session activation notification for all POs; or
sending, by the NG-RAN node, the multicast group paging to one or more determined UE for the MBS multicast session activation notification for relevant POs for one or more UE with a non-activated MBS multicast session, wherein the relevant POs are determined based on a received UE identity index value in the multicast group paging.

5. The method of claim 1, further comprising:
initiating, by one or more UE, at least one of an RRC setup request and an RRC resume request to transition to an RRC connected state from a Radio Resource Control (RRC) idle state or an RRC inactive state to activate a Multicast Broadcast Services (MBS) multicast session upon receiving the MBS multicast session activation notification from the NG-RAN node; and
activating, by one or more UE, the MBS multicast session to start or resume at least one multicast service in the wireless network.

6. The method of claim 4, wherein sending the MBS multicast session activation notification for all POs or the relevant POs is based on at least one factor of number of UEs to be paged in a cell, a paging resource availability with the NG-RAN node, and a specified group paging behaviour of the NG-RAN node or a capability of the NG-RAN node.

7. A method for performing multicast group paging for a Multicast Broadcast Services (MBS) multicast session activation notification in a wireless network, the method comprising:
receiving, by a second Next Generation Radio Access Network (NG-RAN) node, a Radio Access Network (RAN) multicast group paging message from a first NG-RAN node;
determining, by the second NG-RAN node, one or more User Equipment (UE) that has to be paged for the MBS multicast session activation notification based on the received RAN multicast group paging message;
determining, by the second NG-RAN node, one or more Paging Occasion (PO) to send the page for the MBS multicast session activation notification based on the received RAN multicast group paging message; and
performing, by the second NG-RAN node, the multicast group paging for one or more determined UE, wherein the second NG-RAN node pages the MBS multicast session activation notification to one or more determined UE based on the determined one or more PO.

8. The method of claim 7, wherein the RAN multicast group paging message comprises at least one of a message type, an MBS session Identity (ID), a UE identity index list, a UE identity index item, a UE identity index value, an index length, a paging Discontinuous Reception (DRX) including at least one of a UE specific DRX parameter and a common DRX parameter, and a multicast RAN paging area.

9. The method of claim 7 wherein one or more UE operates in a Radio Resource Control (RRC) idle state or an RRC inactive state with a non-activated MBS multicast session.

10. The method of claim 7, wherein the performing, by the second NG-RAN node, of the multicast group paging for one or more determined UE based on the determined one or more PO comprises:
sending, by the second NG-RAN node, the multicast group paging to one or more determined UE for the MBS multicast session activation notification for all POs; or
sending, by the second NG-RAN node, the multicast group paging to one or more determined UE for the MBS multicast session activation notification for relevant POs for one or more UE with a non-activated MBS multicast session, wherein the relevant POs are determined based on a received UE identity index value in the RAN multicast group paging.

11. The method of claim 7, further comprising:
initiating, by one or more UE, at least one of a RRC setup request and a RRC resume request to transition to an RRC connected state from a Radio Resource Control (RRC) idle state or an RRC inactive state to activate a Multicast Broadcast Services (MBS) multicast session upon receiving the MBS multicast session activation notification from the second NG-RAN node; and
activating, by one or more UE, the MBS multicast session to start or resume at least one multicast service in the wireless network.

12. The method of claim 10, wherein the sending of the MBS multicast session activation notification for all POs or the relevant POs is based on at least one factor of number of UEs to be paged in a cell, a paging resource availability with the NG-RAN node, and a specified group paging behaviour of the NG-RAN node or a capability of the NG-RAN node.

13. A method for performing multicast group paging for a Multicast Broadcast Services (MBS) multicast session activation notification in a wireless network, the method comprising:
receiving, by a gNodeB Distributed Unit (gNB-DU) node, a multicast group paging message from a gNodeB Centralized Unit (gNB-CU) node;
determining, by the gNB-DU node, one or more User Equipment (UE) that has to be paged for the MBS multicast session activation notification based on the received multicast group paging message;
determining, by the gNB-DU node, one or more Paging Occasion (PO) to send a page for the MBS multicast session activation notification based on the received multicast group paging message; and
performing, by the gNB-DU node, the multicast group paging for one or more determined UE, wherein the gNB-DU node pages the MBS multicast session activation notification to one or more determined UE based on the determined one or more PO.

14. The method as claimed in of claim 13, wherein the multicast group paging message comprises at least one of a message type, an MBS session Identity (ID), a UE identity list for paging, a UE identity for paging item, a UE identity index value, a paging Discontinuous Reception (DRX) including at least one of a UE specific DRX parameter and a common DRX parameter, a paging cell list, and a paging cell item.

15. A method for performing multicast group paging for Multicast Broadcast Services (MBS) multicast session activation notification in a wireless network, the method comprising:
receiving, by a User Equipment (UE), an MBS multicast session activation notification from at least one of a Next Generation Radio Access Network (NG-RAN) node and a gNodeB Distributed Unit (gNB-DU) node, wherein the UE operates in a Radio Resource Control (RRC) idle state or an RRC inactive state;
initiating, by the UE, at least one of an RRC setup request and an RRC resume request to transition to an RRC connected state from the RRC idle state or the RRC inactive state to activate a Multicast Broadcast Services (MBS) multicast session upon receiving the MBS multicast session activation notification; and
activating, by the UE, the MBS multicast session to start or resume at least one multicast service in the wireless network.

16. A method for performing multicast group paging for Multicast Broadcast Services (MBS) multicast session activation notification in a wireless network, the method comprising:
receiving, by an Access and Mobility Management Function (AMF) node an MBS session notification request from a SMF node);
sending, by the AMF node, an MBS notification response to the SMF node upon receiving the MBS session notification request;
determining, by the AMF node), that one or more UEs in a Connection Management-idle (CM-idle) state and involved in the MBS Session;
determining a paging area considering all the UEs, which need to be paged; and
sending, by the AMF node, a paging request message to a Next Generation Radio Access Network (NG-RAN) node.

17. A User Equipment (UE) for performing multicast group paging for a Multicast Broadcast Services (MBS) multicast session activation notification in a wireless network, the UE comprising:
a memory;
a processor; and
a group paging controller operably connected to the memory and the processor, and configured to:
receive an MBS multicast session activation notification from at least one of a Next Generation Radio Access Network (NG-RAN) node and a gNodeB Distributed Unit (gNB-DU) node, wherein the UE operates in a Radio Resource Control (RRC) idle state or an RRC inactive state,
initiate at least one of an RRC setup request and an RRC resume request to transition to an RRC connected state from the RRC idle state or the RRC inactive state to activate a Multicast Broadcast Services (MBS) multicast session upon receiving the MBS multicast session activation notification, and
activate the MBS multicast session to start or resume at least one multicast service in the wireless network.

18. A Next Generation Radio Access Network (NG-RAN) node for performing multicast group paging for a Multicast Broadcast Services (MBS) multicast session activation notification in a wireless network, the NG-RAN node comprising:
a memory;
a processor; and
a group paging controller operably connected to the memory and the processor, and configured to:
receive a multicast group paging message from an Access and Mobility Management Function (AMF) node,
determine one or more User Equipment (UE) that has to be paged for the MBS multicast session activation notification based on the received multicast group paging message,
determine one or more Paging Occasion (PO) to send the page for the MBS multicast session activation notification based on the received multicast group paging message, and
perform the multicast group paging for one or more determined UE, wherein the NG-RAN node pages the MBS multicast session activation notification to one or more determined UE based on the determined one or more PO.

19. A gNodeB Distributed Unit (gNB-DU) node for performing multicast group paging for a Multicast Broadcast Services (MBS) multicast session activation notification in a wireless network, the gNB-DU node comprising:
a memory;
a processor; and
a group paging controller operably connected to the memory and the processor, and configured to:
receive a multicast group paging message from a gNodeB Centralized Unit (gNB-CU) node,
determine one or more User Equipment (UE) that has to be paged for the MBS multicast session activation notification based on the received multicast group paging message,
determine one or more Paging Occasion (PO) to send a page for the MBS multicast session activation notification based on the received multicast group paging message, and
perform the multicast group paging for one or more determined UE, wherein the gNB-DU node pages the MBS multicast session activation notification to one or more determined UE based on the determined one or more PO.

20. An Access and Mobility Management Function (AMF) node for performing multicast group paging for a Multicast Broadcast Services (MBS) multicast session activation notification in a wireless network, the AMF node comprising:
a memory;
a processor; and
a group paging controller operably connected to the memory and the processor, and configured to:
receive an MBS session notification request from a SMF node,
send an MBS notification response to the SMF node upon receiving the MBS session notification request,
determine that one or more UEs in a Connection Management-idle (CM-idle) state and involved in the MBS Session,
determine a paging area considering all the UEs, which need to be paged, and
send a paging request message to a Next Generation Radio Access Network (NG-RAN) node.
